(19) United States
(12) Patent Application Publication
(10) Pub. No.: US 2015/0293636 A1
(43) Pub. Date: Oct. 15, 2015

(54) SENSING APPARATUS

(71) Applicant: POSTECH ACADEMY-INDUSTRY FOUNDATION, Pohang-si Gyeongsangbuk-do (KR)

(72) Inventors: Hong June Park, Pohang-si (KR); Sang Su Lee, Daegu (KR); Dong Hee Yeo, Seoul (KR); Jae Seung Lee, Pohang-si, Gyeongsangbuk-do (KR)

(73) Assignee: POSTECH ACADEMY-INDUSTRY FOUNDATION, Pohang-si, Gyeongsangbuk-do (KR)

(21) Appl. No.: 14/346,230

(22) PCT Filed: Dec. 4, 2013
(86) PCT No.: PCT/KR2013/011138

§ 371 Date: Mar. 20, 2014

(30) Foreign Application Priority Data
Dec. 6, 2012 (KR) 10-2012-0140712

(51) Int. Cl. G06F 3/041; G06F 3/044

(52) U.S. Cl. CPC G06F 3/0412; G06F 3/044

(57) ABSTRACT

The present invention relates to a sensor circuit method for securing a sufficient Signal to Noise Ratio (SNR) by reducing the influence of noise induced from a sensor element which appears in the final output signal of a reception unit although an input signal having a relatively small amplitude is used in a sensing apparatus in which a time-periodic signal having a relatively higher frequency as compared with the speed of change of a behavior of a user or a movement of an object to be sensed, such as a capacitive sensor or an inductive sensor, is used as an input signal. Power consumption of a touch sensor chip can be reduced even without increasing the amplitude of a touch sensor panel driving signal, and a production cost for a touch sensor chip can be reduced by removing a high voltage driver.

### BACKGROUND OF THE INVENTION

1. Field of the Invention

The present invention relates to a sensor circuit method for securing a sufficient Signal to Noise Ratio (SNR) by reducing the influence of noise induced from a sensor element which appears in the final output signal of a reception unit although an input signal having a relatively small amplitude is used in a sensing apparatus in which a time-periodic signal having a relatively higher frequency as compared with the speed of change of a behavior of a user or a movement of an object to be sensed, such as a capacitive sensor or an inductive sensor, is used as an input signal. More particularly, in order to illustrate embodiments of the present invention, the contents of the present invention have been applied to a touch sensor which is used in flat panel displays, such as a Liquid Crystal Display (hereinafter referred to as an ‘LCD’) and Organic Light-Emitting Diodes (hereinafter referred to as an ‘OLED’). The present invention illustrates embodiments regarding a touch sensing apparatus capable of securing a sufficient SNR although an input signal having a relatively small amplitude is used by reducing the influence of noise that is generated within a flat panel display and induced from a touch sensor panel.

2. Description of the Related Art

A capacitive sensor or an inductive sensor is used for various purposes. In a capacitive sensor and an inductive sensor, in order to sense a behavior of a user or a movement of an object through a sensor apparatus, a time-periodic signal having a relatively high frequency as compared with the speed of change of a behavior of the user or a movement of the object is used as an input signal. This is because only when the input signal has a relatively high frequency, an output signal having a relatively high value can be obtained through a capacitive method or a magnetic coupling phenomenon in the sensor apparatus. However, the amplitude of a driving signal inputted to the sensor apparatus needs to be greatly increased in order to obtain a sufficient SNR because noise components induced from the sensor apparatus also appear in the output signal of a sensor circuit.

In order to illustrate more detailed embodiment of the present invention, a touch sensor circuit including a touch sensor panel attached to a flat panel display device, such as an LCD and OLEDs, has been applied to the present invention.

In recent portable phones or tablet PCs, a touch sensor panel is attached to a flat panel display device in an LCD and OLEDs, and the touch sensor panel is used as an input device through a touch operation using a finger or a pen.

A resistive touch method was chiefly used in initial touch sensor panels. However, the initial touch sensor panels are disadvantageous in that they have a short lifespan because a mechanical movement must be transferred for touch sensing. In order to supplement the disadvantage, a capacitive touch sensor panel from which a mechanical movement has been removed using tempered glass is chiefly used. The capacitive touch sensor panel has a structure in which a glass plane for a touch sensor panel is placed on a flat panel display and tempered glass is attached to the glass plane. Although a finger or a pen touches the tempered glass, a mechanical movement is not delivered to the glass plane for the touch sensor panel placed under the tempered glass and a flat panel display device. Accordingly, the capacitive touch sensor panel does not have a disadvantage in that the lifespan of a display device is reduced by repetitive touch operations.

Electrodes that are not electrically coupled and are disposed to cross each other are disposed in the glass plane for the capacitive touch sensor panel. The electrodes are commonly implemented using transparent electrodes (i.e., indium tin oxide) or nano wires. The capacitive touch sensor panel can be divided into a method of measuring self-capacitance and a method of measuring mutual capacitance. At the early stage, the method of measuring self-capacitance was chiefly used. As the number of touches that are made at the same time becomes 3 or more, the method of measuring mutual capacitance is gradually used a lot. Here, the term ‘self-capacitance’ is capacitance between each line and a reference node, and the term ‘mutual capacitance’ is capacitance between two lines that cross each other. A reference node (ground) of self-capacitance corresponds to the terminal of an LCD common electrode VCOM in the case of an LCD and corresponds to a common cathode terminal in the case of OLEDs.

In the capacitive touch method of measuring mutual capacitance, however, an SNR is very small due to common electrode (VCOM) noise which is generated from a flat panel display, such as an LCD or OLEDs. Here, the common electrode (VCOM) noise generally refers to LCD common electrode (VCOM) noise and OLED common cathode electrode noise. Accordingly, in such a capacitive touch method, a scheme for reducing the influence of the common electrode (VCOM) noise generated from a flat panel display is essential.

Prior to a description of the principal technical spirit of the present invention, the structure of the LCD needs to be first understood. In the present invention, only the structure of the LCD is described because the common electrode (VCOM) noise is generated in OLEDs according to a mechanism similar to that of the LCD. A current LCD may be basically divided into a Vertical Alignment (VA) method and an In-Plane Switching (IPS) method.

In the VA method, as shown in FIG. 1A, the node of a common electrode VCOM is close to a capacitive touch sensor panel electrode because it is placed in the upper glass substrate of a plane LCD which is far from the backlight of the LCD, of two glass substrates forming the LCD.

In the IPS method, as shown in FIG. 1B, the node of a common electrode VCOM is far from a capacitive touch sensor panel electrode because it is placed in the lower glass substrate of an LCD which is close to the backlight of the LCD, of two glass substrates forming the LCD. In the IPS method, however, the touch sensor panel electrode is directly exposed to a video signal analog (i.e., gray scale signal) that drives a TFT or a source driver because a conductive plane is not present between the touch sensor panel and the LCD other than an electrostatic prevention film having a relatively high resistance value.

A pixel of the LCD includes two electrodes, liquid crystals placed between the two electrodes, a color filter, etc. The electrodes are formed of transparent electrodes made of Indium Tin Oxide (ITO) over the glass plane. As shown in FIG. 2, an analog signal indicative of gray scale that is received from a source driver through a TFT switch is applied to one of the two electrodes. DC voltage of about 5 V is applied to all the pixels of the other common node in common. Such a common node is called a common electrode (VCOM) node. In general, the capacitive touch sensor panel does not include a ground or reference electrode in the touch sensor panel, and an LCD common electrode (VCOM) node serves as the reference voltage node of the capacitive touch sensor panel because the capacitive touch sensor panel is placed on the LCD.

Referring to FIG. 2, in the LCD, gate driver lines G1 to G3 corresponding to respective rows are sequentially driven according to their positions. The gate nodes of a large number (about 6000 in the case of full HD) of TFT switches are coupled to each gate driver line. Accordingly, relatively high capacitance of several tens of pF is applied to one gate driver line. A gate driving signal maintains a value of about −5 V upon turn-off and maintains a value of about +25 V upon turn-on. Accordingly, since a very great voltage shift is generated at the rising edge and fall edge of the gate driver signal for a short time, a very high displacement current I_{N}(t) that may be indicated by ‘CdV/dt’ flows into the LCD common electrode (VCOM) node through the gate capacitor C_{GD} and the liquid crystal capacitor C_{LC} of the TFT.

FIG. 3 is a diagram showing a mechanism in which common electrode (VCOM) noise is generated due to the driving signal of the gate driver line shown in FIG. 2. Referring to FIG. 3, the displacement current I_{N}(t) passes through the common electrode (VCOM) plane formed of the transparent electrode and then flows into the output resistor RO of an LCD common electrode (VCOM) driver. A waveform of the LCD common electrode VCOM appears in an impulse form at the rising edge and falling edge of the gate driver signal.

As shown in FIG. 2, however, the gate driver signal sequentially moves to a next gate driver line. Common electrode (VCOM) noise has a waveform of an impulse form in each of the rising edge and falling edge of the gate driver signal in all the gate driver lines.

The capacitive touch method, as described above, is divided into the method of measuring self-capacitance and the method of measuring mutual capacitance. A value of self-capacitance is increased because capacitance between the human body and the earth is added when a touch is performed. Accordingly, whether a touch is present or not is determined based on such a phenomenon. Furthermore, self-capacitance is relatively insensitive to LCD common electrode (VCOM) noise because it has a relatively high value of about 20 pF or more.

In the capacitive touch method, however, if the number of simultaneous touch positions is 3 or more, mutual capacitance needs to be measured. If there is a touch operation, a mutual capacitance value between two electrodes that cross each other at a touch position is decreased. The mutual capacitance value is about 1 pF, and the mutual capacitance value is decreased by about 10% to 20% due to the touch operation. As shown in FIG. 8 of the present invention, the electrode X[j] of mutual capacitance on one side is coupled to the inverting input terminal of a charge amplifier, and the electrode Y[i] thereof on the other side is coupled to a driving signal generation unit 120. The C_{M,i,j} is mutual capacitance between an i^{th} Y electrode Y[i] and a j^{th} X electrode X[j]. When a touch operation is generated at a position where the electrode Y[i] intersects the electrode X[j], a value of the mutual capacitance C_{M,i,j} is reduced by about 10% to 20%, and thus the output voltage amplitude of the charge amplifier is also reduced. This is because the output voltage amplitude of the charge amplifier is the same as a value obtained by multiplying the voltage amplitude of the driving signal by a value C_{M,i,j}/C_{F} at the same ratio as a change of the mutual capacitance C_{M,i,j}. Here, voltage obtained by multiplying common node noise (VCOM) noise voltage by the value C_{SXj}/C_{F} is added to the output voltage of the charge amplifier through self-capacitance C_{SXj} between the touch sensor panel electrode X[j] to which the inverting input terminal of the charge amplifier is coupled and the common node (VCOM) electrode.

In general, the common electrode (VCOM) noise amplitude is smaller than the amplitude of the touch sensor panel driving signal, but the self-capacitance C_{SXj} is 20 times or more than the mutual capacitance C_{M,i,j}. Accordingly, the SNR of the output signal of the charge amplifier is usually smaller than 1. In such a condition, in order to overcome LCD common electrode (VCOM) noise and determine whether or not a touch is present stably in a touch sensor using the mutual capacitance measurement method, a touch sensor using a noise reduction method is indispensable.

In a touch sensor using the mutual capacitance measurement method, a method of increasing the SNR of the output voltage of the charge amplifier by reducing the influence of common electrode (VCOM) noise that is generated from a flat panel display may include the following methods.

(1) A chopper method,

(2) A method of increasing the amplitude of the driving signal of a touch sensor panel,

(3) A method of controlling the frequency of the driving signal of a touch sensor panel, and

(4) A method of driving a touch sensor panel only in a time interval in which a flat panel display does not operate.

First, the chopper method is a method of reducing the influence of common electrode (VCOM) noise at the output of the integrator or the low-pass filter by applying the same signal as a driving signal applied to the capacitive touch sensor panel to the reception circuit unit, multiplying the output signal of the charge amplifier of the reception circuit unit and the same signal as the driving signal together in the chopper circuit, and passing an output signal thereof through the integrator or the low-pass filter.

Second, the method of increasing the amplitude of the driving signal of a touch sensor panel is a method of increasing the amplitude of the driving signal of the touch sensor panel in order to increase the SNR of the output signal of the reception circuit unit to 1 or more.

Third, the method of controlling the frequency of the driving signal of a touch sensor panel is a method of finding a frequency having a small noise size in the frequency spectrum of common electrode (VCOM) noise and controlling the frequency of the driving signal so that it becomes identical with the frequency [U.S. Patent Laid-Open Publication No. US 2008/0157882]

Fourth, the method of driving a touch sensor panel only in a time interval in which a flat panel display does not operate is a method of driving a touch sensor circuit only in a VBLANK interval, that is, a time interval until the screen of a next frame is transmitted after the screen of 1 frame is fully transmitted in a flat panel display, because common electrode (VCOM) noise is not generated in the VBLANK interval [U.S. Patent Laid-Open Publication No. US 2009/0009483]

In order to increase the SNR of the output voltage of the charge amplifier to 1 or more, a peak-to-peak voltage value of the driving signal was 20 V or more, but the peak-to-peak voltage value has recently been reduced to about 5 V through a combination of some of the methods. However, 5 V is much higher than the supply voltage of a semiconductor chip. Accordingly, if the peak-to-peak voltage value of a driving signal is reduced to about 3 V or 1 V using an additional VCOM noise reduction scheme, there is an advantage in that the supply voltage of a semiconductor chip which is now used can be used in a driving signal generation unit even without adding an additional supply voltage.

### SUMMARY OF THE INVENTION

Accordingly, the present invention has been made in an effort to solve the problems occurring in the related art, and an object of the present invention is to provide a sensing apparatus in which the final output signal of a sensor circuit can maintain a relatively high SNR value by reducing the influence of noise induced from a sensor element while maintaining a relatively small value in the amplitude of an input signal in the sensing apparatus using a time-periodic signal as the input signal. In order to illustrate more detailed embodiments of the present invention, the contents of the present invention have been applied to a capacitive touch sensor such that the amplitude of an input signal can maintain a relatively small value and whether or not a touch is present and a touched position can be reliably determined in such a way as to be insensitive to noise generated from a flat panel display.

In order to achieve the above object, according to one aspect of the present invention, there is provided a sensor using a sensor element measurement method, including a period signal generation unit 110 configured to generate time-periodic signals, a driving signal generation unit 120 configured to generate a driving signal for a sensor element 130 using the output signal of the period signal generation unit 110 and a feedback signal, the sensor element 130 configured to have an input terminal coupled to the output terminal of the driving signal generation unit 120 and to have an output terminal coupled to the input terminal of a first reception unit 150, the first reception unit 150 configured to couple a charge amplifier to the output terminal of the sensor element 130 and to generate an output signal proportion to the output of the charge amplifier, a second reception unit configured to receive some of the output signals of the first reception unit 150 and the output signals of the period signal generation unit 110 and to generate a low frequency output signal proportion to the driving signal of the sensor element 130 or a difference between the some output signals, and a feedback signal generation unit 140 configured to receive the output signals of the first reception unit 150 and to output feedback signals of the received output signals to the driving signal generation unit 120. Here, if the present invention for measuring the sensor element 130 is applied to a touch sensor panel using a mutual capacitance measurement method, a flat panel display for displaying an image and an on-cell or in-cell touch sensor panel placed on the flat panel display or embedded in the flat panel display are included.

### BRIEF DESCRIPTION OF THE DRAWINGS

The above objects, and other features and advantages of the present invention will become more apparent after a reading of the following detailed description taken in conjunction with the drawings, in which:

FIG. 1A is a diagram showing the cross section of a conventional LCD using a Vertical Alignment (VA) method; FIG. 1B is a diagram showing the cross section of an LCD using an In Plane Switching (IPS) method;

FIG. 2 is a diagram showing the sequential driving operation of gate driver lines shown in FIGS. 1A and 1B;

FIG. 3 is a diagram showing a mechanism in which common electrode (VCOM) noise is generated due to the driving signal of the gate driver line shown in FIG. 2;

FIG. 4 is a block diagram of the present invention;

FIG. 5 is a more detailed block diagram of the present invention. FIG. 5 shows a more detailed example of the present invention shown in FIG. 4 and shows a sensing apparatus in which a variable sensor element 131 for generating an output signal proportional to physical quantity used to measure a sensor element and a fixed sensor element 133 for generating a constant output signal irrespective of the physical quantity are separated and implemented;

FIG. 6 is a diagram showing an example in which the present invention has been applied to a capacitive touch sensing apparatus;

FIG. 7 is a detailed diagram of a reception unit shown in FIG. 6;

FIG. 8 is a diagram showing the layout of a touch sensor panel shown in FIG. 6;

FIG. 9 is a diagram showing the structure of a conventional capacitive touch sensing apparatus that uses a mutual capacitance measurement method in which a charge amplifier is coupled to a first reception unit;

FIG. 10A is a diagram showing an embodiment in which the spirit of the present invention has been applied to a capacitive touch;

FIG. 10B shows one of embodiments of a second reception unit in accordance with the present invention;

FIG. 10C shows one of circuit embodiments showing the embodiment of FIG. 10A in more detail;

FIG. 10D is a diagram showing another embodiment of the second reception unit in accordance with the present invention;

FIG. 11 is a diagram showing an example in which the amplifier of the first reception unit in accordance with the present invention has been implemented in a band-pass filter form;

FIG. 11B is a diagram showing the amplifier of the first reception unit in accordance with the present invention in more detail;

FIG. 12A shows a waveform of flat panel display noise VCOM which is used in the present invention;

FIG. 12B shows characteristics of the output voltage of the amplifier used in the present invention;

FIG. 12C shows other characteristics of the output voltage of the amplifier used in the present invention;

FIG. 13 is a diagram showing an example in which the output voltage of the conventional capacitive touch sensing apparatus is compared with the output voltage of the first reception unit 150 of the sensing apparatus in accordance with the present invention in a frequency domain; and

FIG. 14 shows an output waveform of the LPF of the second reception unit according to a change of mutual capacitance.

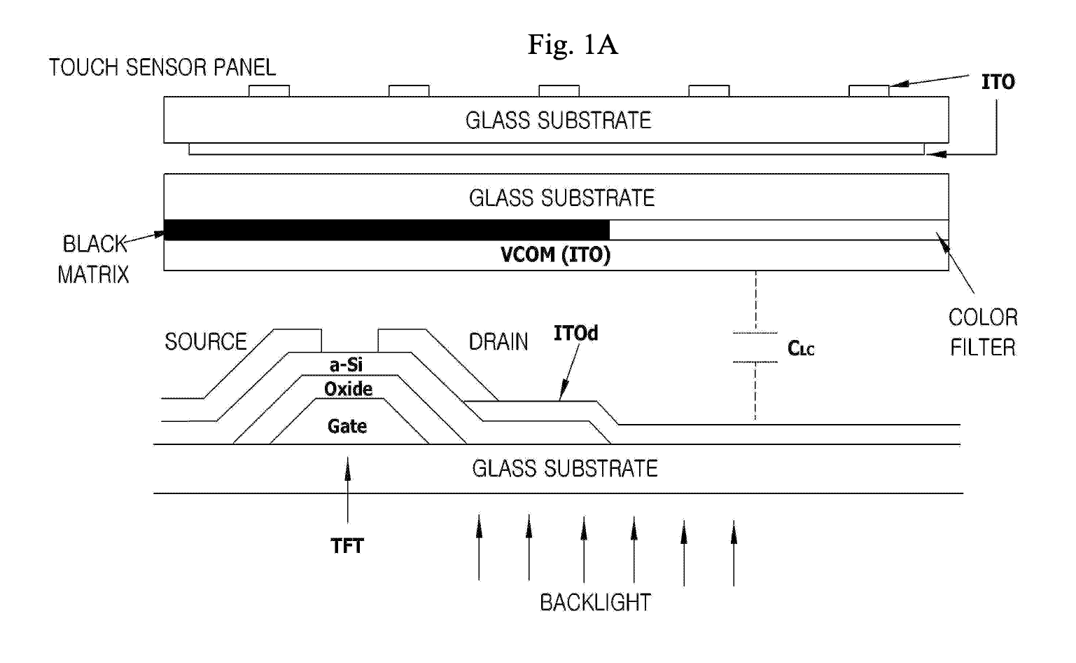

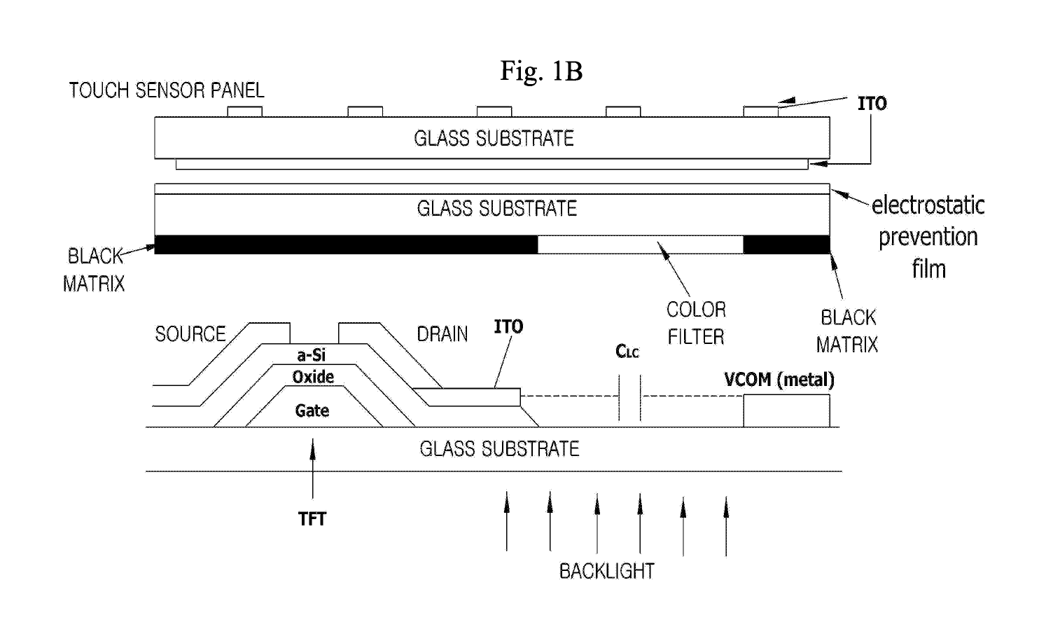

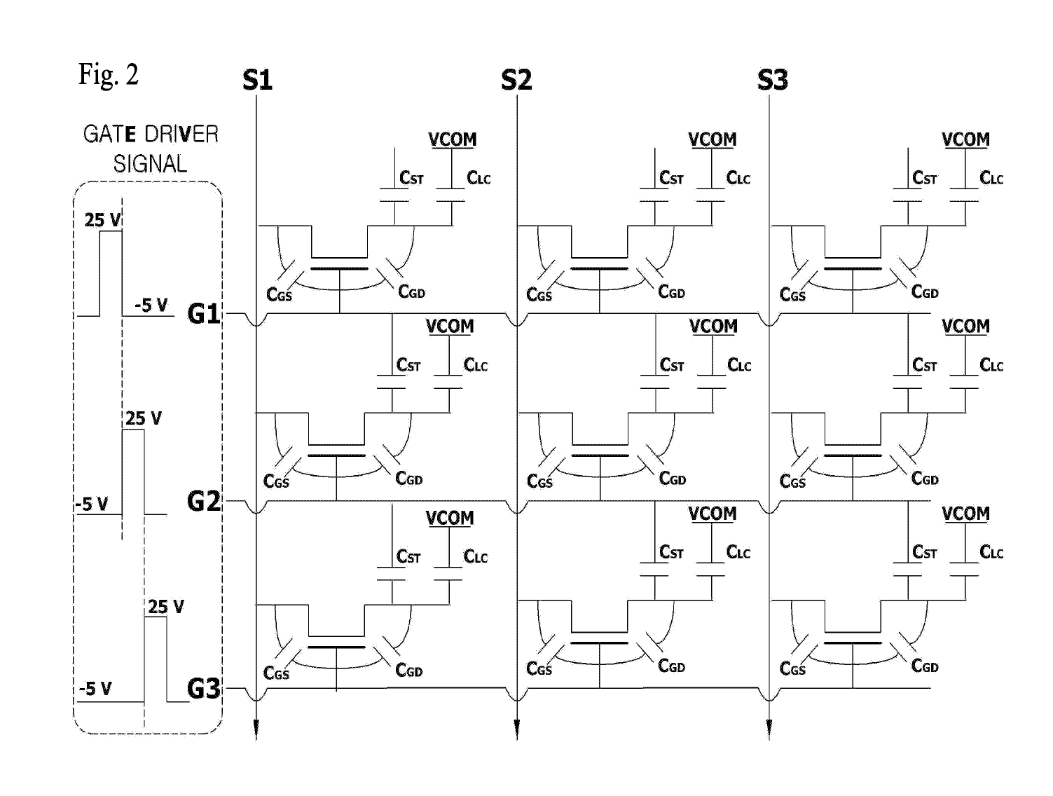

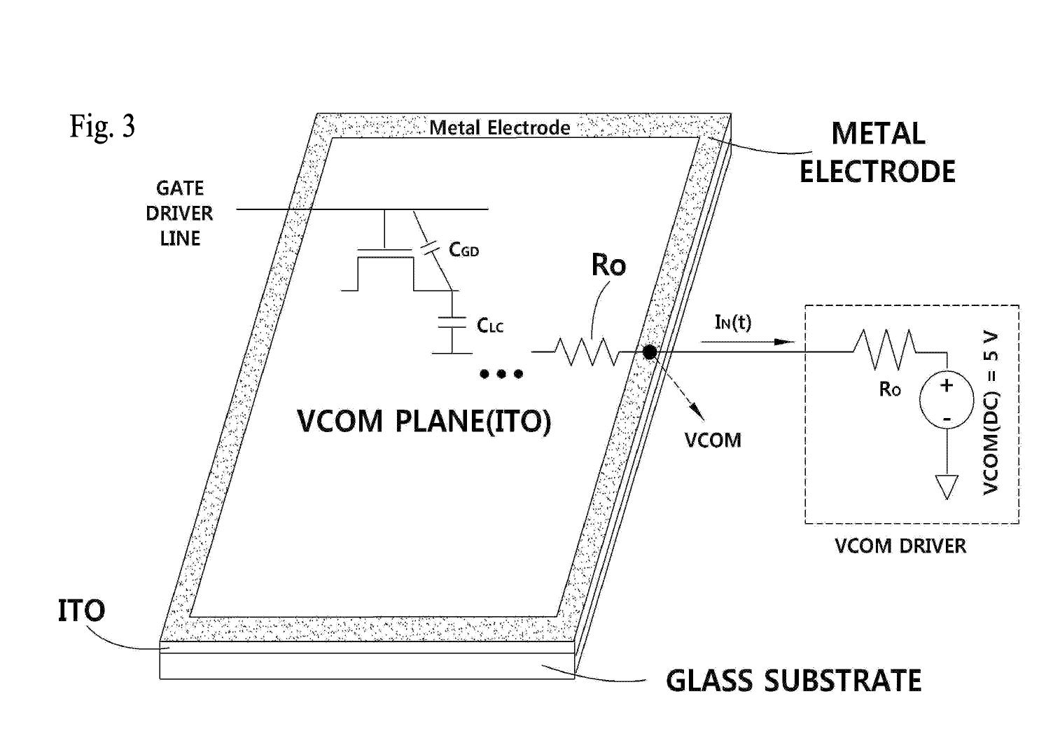

### DETAILED DESCRIPTION OF PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

Hereinafter, detailed embodiments of the present invention are described in detail with reference to the accompanying drawings. Each of elements or characteristics may be considered to be optional unless otherwise described explicitly. Each element or characteristic may be implemented in such a way as not to be combined with other elements or characteristics. Furthermore, some of the elements and/or the characteristics may be combined to form an embodiment of the present invention. Order of operations described in the embodiments of the present invention may be changed. Some of the elements or characteristics of an embodiment may be included in another embodiment or may be replaced with corresponding elements or characteristics of another embodiment.

In a description of the drawings, a procedure or step that may make obscure the technical spirit of the present invention is not described, and a procedure or step that may be easily understood by those skilled in the art is also not described. Furthermore, the same elements are assigned the same reference numerals through the specification.

Specific terms used in the embodiments of the present invention are provided to help understanding of the present invention, and such specific terms may be changed into other forms without departing from the technical spirit of the present invention.

Some exemplary embodiments of the present invention are described in detail with reference to the accompanying drawings. A detailed description to be disclosed along with the accompanying drawings are intended to describe some exemplary embodiments of the present invention and are not intended to a sole embodiment of the present invention.

A “behavior of a user or a movement of an object” used through the specification of the present invention refers to a behavior directly performed by a user or through an object in order to achieve an intention of driving a device to which the sensing apparatus of the present invention has been applied. For example, the behavior of a user or the movement of an object includes an operation of touching a panel through part of the human body of a user or a toll used by a user and an operation of bringing part of the human body of a user or a toll used by a user close to the panel in order to derive capacitive coupling in the case of a capacitive touch panel and in order to derive inductive coupling in the case of a magnetic touch panel.

It is noted that the sensing apparatus of the present invention recognizes capacitive coupling, inductive coupling, a change of the amount of light, and a change of a frequency, voltage, etc. which are generated by such a “behavior of a user or a movement of an object” as an intended input of a user.

It is also noted that a “behavior of a user or a movement of an object” does not include the remaining unintentional operations other than an operation in which a user drives a device including the sensing apparatus of the present invention. For example, natural changes, such as a surrounding temperature, atmosphere, and humidity, are not included in a “behavior of a user or a movement of an object”.

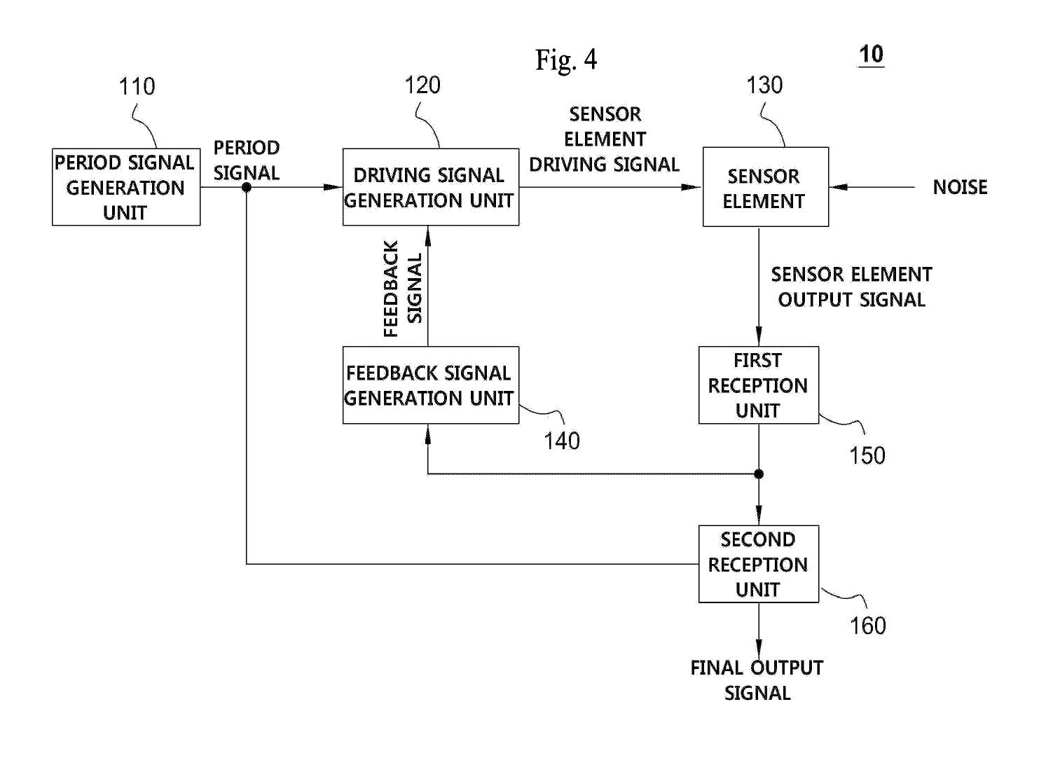

FIG. 4 is a schematic block diagram of the present invention and a diagram showing an example in which the present invention has been applied to a sensing apparatus using a time-periodic signal as input. The sensing apparatus using a time-periodic signal as input can be applied to all sensing apparatuses, such as a capacitive sensing apparatus and an inductive sensing apparatus, which uses a time-periodic signal having a relatively high frequency, as compared with the speed of a behavior of a user or a change of an environment to be sensed, as input in order to couple the input side of a sensing element to which an input signal is applied and the output side of the sensing element from which an output signal is obtained. A sensing apparatus to which the present invention can be applied includes various types of capacitive sensing apparatuses using an electrical coupling phenomenon, including a capacitive touch sensor, and various types of magnetic sensing apparatuses using a magnetic coupling phenomenon. A conventional sensing apparatus is disadvantageous in that noise induced from a sensor element 130 is not attenuated and the noise appears in the final output signal of a second reception unit 160 because it uses an input signal as a driving signal without a driving signal generation unit 120 and a feedback signal generation unit 140 of FIG. 4. In the present invention of FIG. 4, a driving signal is generated using a signal in which the output signal of the feedback signal generation unit 140 and the output signal of a period signal generation unit 110 are combined by applying the output signal of a first reception unit 150 to the feedback signal generation unit 140. Accordingly, noise induced from the sensor element 130 is attenuated and thus the attenuated noise appears in the final output signal of the second reception unit 160 in accordance with a negative feedback circuit operation including the driving signal generation unit 120, the sensor element 130, the first reception unit 150, and the feedback signal generation unit 140. The sensor element 130 may include a flat panel display, such as an LCD or OLEDs in which a panel capable of recognizing a touch operation is embedded.

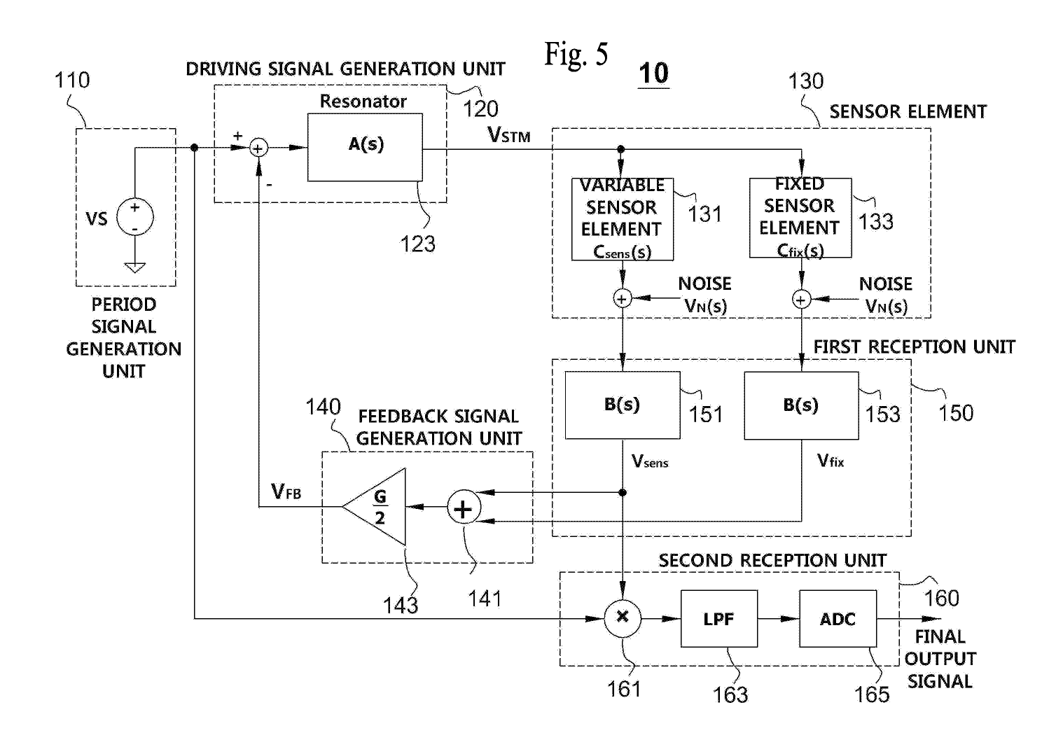

FIG. 5 is a detailed block diagram of the sensing apparatus 10 in accordance with the present invention. Referring to FIG. 5, the driving signal generation unit 120 generates a signal in which the output signal V_{FB} of the feedback signal generation unit 140 has been subtracted from the output signal of the period signal generation unit 110 and outputs a signal, obtained by passing the generated signal through a resonator 123, as the output signal V_{SIM} of the driving signal generation unit 120. The sensor element 130 includes a variable sensor element 131 Cₛₑₙₛ for generating an output signal that is proportional to physical quantity to be measured and a fixed sensor element 133 C_{fix} for generating a output signal that is constant irrespective of the physical quantity. Here, the variable sensor element 131 Cₛₑₙₛ and the fixed sensor element 133 C_{fix} are separately implemented. The first reception unit 150 is separated into a circuit for amplifying the output signal of the variable sensor element 131 and a circuit for amplifying the output signal of the fixed sensor element 133, and both the circuits have the same transfer function. The amplified output signal Vₛₑₙₛ of the variable sensor element 131 of the first reception unit 150 is used as the input signal of the second reception unit 160, and both the amplified output signal Vₛₑₙₛ of the variable sensor element 131 of the first reception unit 150 and the amplified output signal V_{fix} of the fixed sensor element 133 of the first reception unit 150 are used as the input signals of the feedback signal generation unit 140. The feedback signal generation unit 140 outputs a signal that is proportional to the mean value of the two input signals as the output signal V_{FB}.

In FIG. 5, the amplified output signal Vₛₑₙₛ of the variable sensor element 131 of the first reception unit 150 is represented by Equation 1 below. In Equation 1, V_{N} is noise induced from the sensor element 130, A(s) is the transfer function of the resonator 123, and B(s) is the transfer function of an amplifier included in the first reception unit 150.

$${V}_{sens} ( s ) = \frac{A ( s ) B ( s ) {C}_{sens} ( s )}{1 + A ( s ) B ( s ) G \frac{{C}_{sens} ( s ) + {C}_{fix} ( s )}{2}} VS ( s ) + B ( s ) [ \frac{1 - A ( s ) B ( s ) G \frac{{C}_{sens} ( s ) - {C}_{fix} ( s )}{2}}{1 + A ( s ) B ( s ) G \frac{{C}_{sens} ( s ) + {C}_{fix} ( s )}{2}} ] {V}_{N} ( s ) \qquad [ Equation 1 ]$$

In FIG. 5, the transfer function A(s) of the resonator 123 is represented by Equation 2 below.

$$A ( s ) = \frac{{ω}_{0} s}{{s}^{2} + {ω}_{0}^{2}} \qquad [ Equation 2 ]$$

In Equation 2, ‘s’ is the same as jω (wherein j=\sqrt{−1}). Accordingly, in the resonant frequency ω_{O} of the resonator 123 or a signal frequency ω close to the resonant frequency ω₀, a value ‘A(jω)’ is much greater than 1. If the signal frequency ω becomes distant from the resonant frequency ω₀, the value A(jω) becomes smaller than 1. In FIG. 5, if the frequency of the output signal VS of the period signal generation unit 110 is identical with the resonant frequency ω_{O} of the resonator 123, the amplified output signal Vₛₑₙₛ of the variable sensor element 131 of the first reception unit 150 is represented by Equation 3. In this case, if the transfer function Cₛₑₙₛ(jω_{O}) of the variable sensor element 131 and the transfer function C_{fix}(jω_{O}) of the fixed sensor element 133 are made identical with each other, noise induced from the sensor element 130 is offset with the output signal Vₛₑₙₛ of the first reception unit 150, so the noise does not appear in the output signal Vₛₑₙₛ of the first reception unit 150.

$${V}_{sens} ( {jω}_{0} ) \approx \frac{2 {C}_{sens} ( {jω}_{0} )}{G [ {C}_{sens} ( {jω}_{0} ) + {C}_{fix} ( {jω}_{0} )} VS ( {jω}_{0} ) - B ( {jω}_{0} ) [ \frac{{C}_{sens} ( {jω}_{0} ) - {C}_{fix} ( {jω}_{0} )}{{C}_{sens} ( {jω}_{0} ) + {C}_{fix} ( {jω}_{0} )} ] {V}_{N} ( {jω}_{0} ) \qquad [ Equation 3 ]$$

In FIG. 5, the output signal V_{STM} of the driving signal generation unit 120 is represented by Equation 4. If the frequency of the output signal of the period signal generation unit 110 is identical with the resonant frequency ω_{O} of the resonator 123, it is represented by Equation 5. From Equation 5, it can be seen that noise V_{N} induced from the sensor element 130 appears in the output signal V_{STM} of the driving signal generation unit 120 in the direction in which the induced noise V_{N} is offset with the output signal V_{STM}.

$$\begin{matrix}{V}_{STM} ( s ) = \frac{A ( s )}{1 + A ( s ) B ( s ) G \frac{{C}_{sens} ( s ) + {C}_{fix} ( s )}{2}} VS ( s ) - \frac{A ( s ) B ( s ) G}{1 + A ( s ) B ( s ) G \frac{{C}_{sens} ( s ) + {C}_{fix} ( s )}{2}} {V}_{N} ( s ) & [ Equation 4 ] \\ {V}_{STM} ( {jω}_{0} ) \approx \frac{2}{B ( s ) G \{ {C}_{sens} ( {jω}_{0} ) + {C}_{fix} ( {jω}_{0} ) \}} VS ( {jω}_{0} ) - \frac{2}{{C}_{sens} ( {jω}_{0} ) + {C}_{fix} ( {jω}_{0} )} {V}_{N} ( {jω}_{0} ) & [ Equation 5 ]\end{matrix}$$

In FIG. 5, the transfer function B(s) of an amplifier that forms the first reception unit 150 has a band-pass characteristic, thus preventing a phenomenon in which the output terminal voltage of the amplifier of the first reception unit 150 is saturated due to the noise V_{N} induced from the sensor element 130.

An example in which the present invention has been applied to a common sensor has been described above. That is, if a sensing apparatus has only to be a sensing apparatus using a time-periodic signal as input, the present invention can be applied to all capacitive and magnetic sensing apparatuses. In order to illustrate a more detailed embodiment hereinafter, the present invention is applied to a touch sensor used in a flat panel display which includes an LCD or OLEDs. The present invention can be applied to a touch sensing apparatus because the touch sensing apparatus uses a time-periodic signal, for example, a sine wave or a pulse wave as an input signal. If the present invention is applied to a touch sensor, the influence of noise generated from a flat panel display and induced in a touch sensor panel can be reduced. Accordingly, a sufficient SNR can be secured although an input signal having a relatively small amplitude is used.

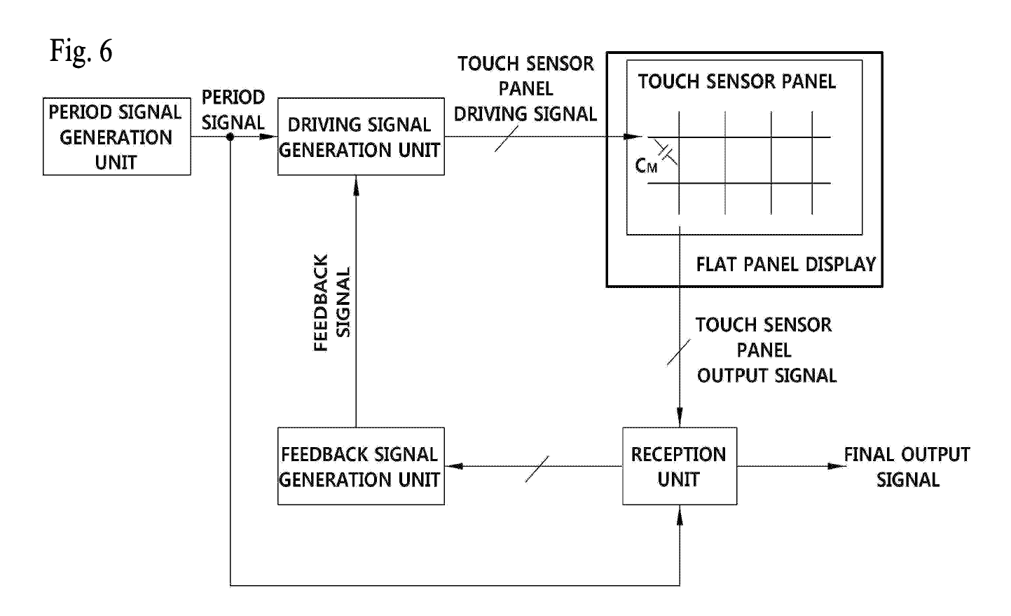

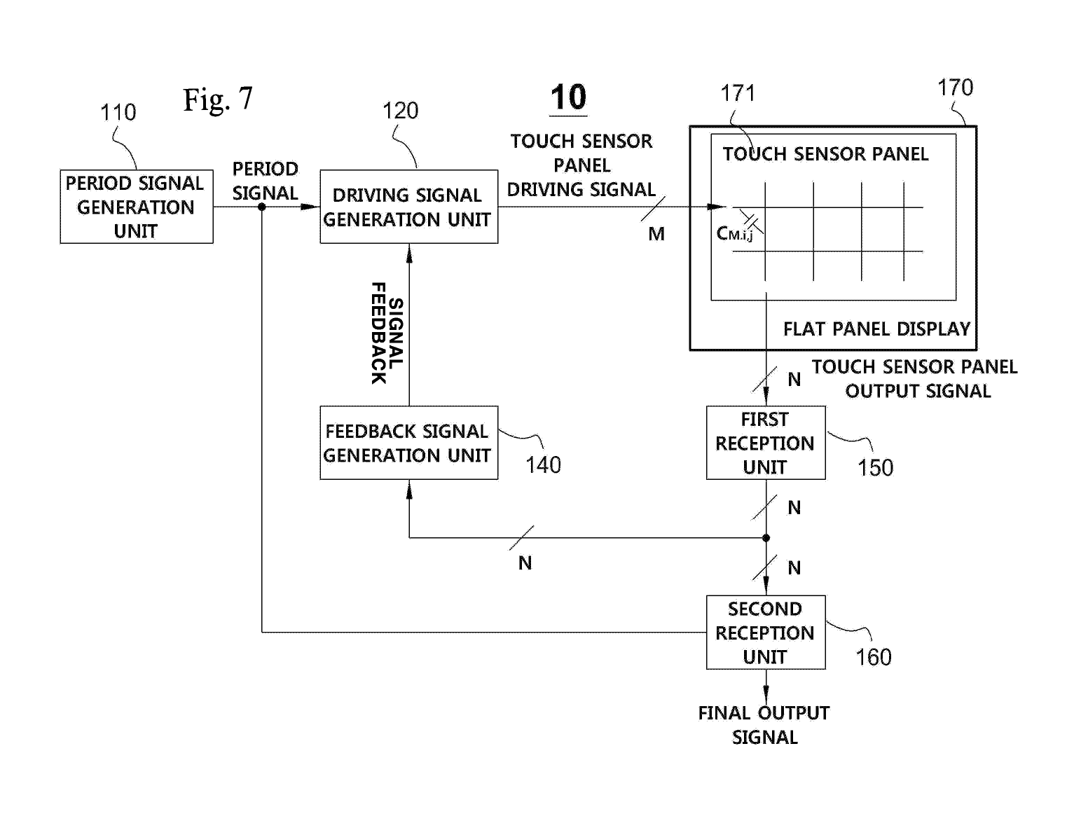

If the present invention is applied to a touch sensor panel using the mutual capacitance measurement method, it results in FIG. 6. FIG. 7 is a detailed diagram of the reception unit shown in FIG. 6.

Referring to FIG. 7, a mutual capacitance measuring type touch sensing apparatus 10 in accordance with the present invention includes a period signal generation unit 110 for generating a period signal, a driving signal generation unit 120 for generating a signal to be applied to a touch sensor panel 171, a first reception unit 150 for processing a signal received from the touch sensor panel 171, a feedback signal generation unit 140 for generating a feedback signal using the output signal of the first reception unit 150, and a second reception unit 160 for receiving the output signal of the first reception unit 150 and the output signal of the period signal generation unit 110 as input. In the present embodiment, the touch sensor panel 171 is attached over a flat panel display 170. In some embodiments, the present invention may be applied to an in-cell form in which the touch sensor panel is embedded in the flat panel display in addition to an on-cell form in which the touch sensor panel is placed over the flat panel display.

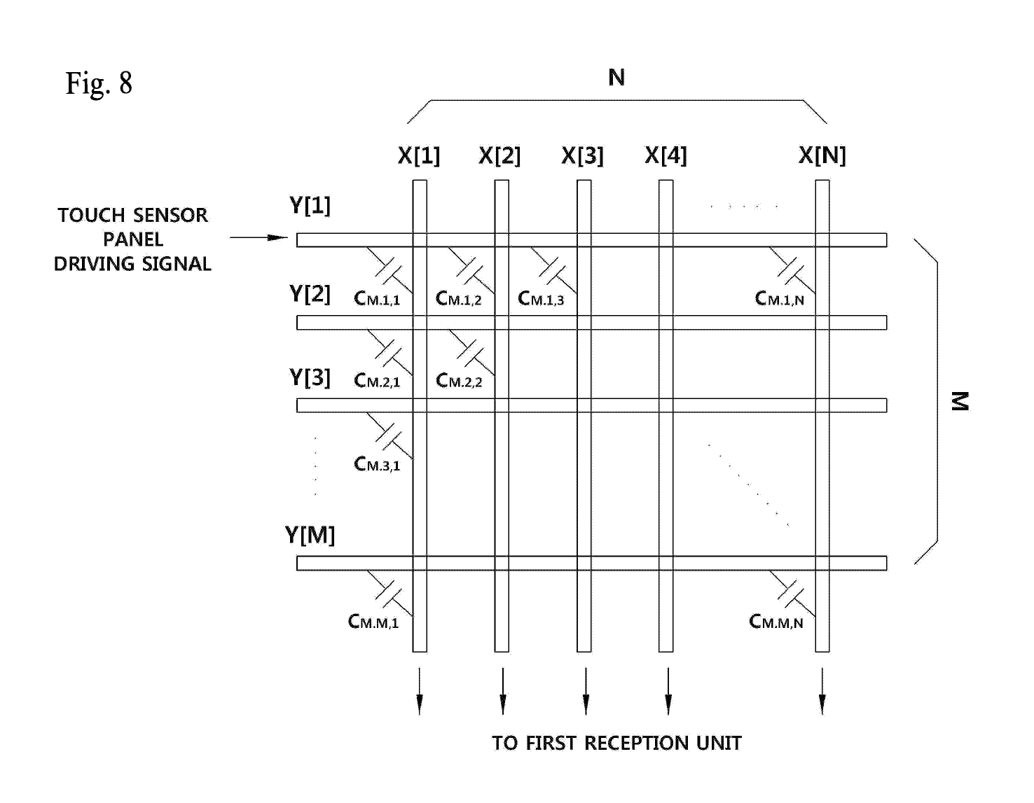

FIG. 8 is a diagram showing the layout of the touch sensor panel 171 shown in FIG. 6. The layout shows electrode lines of Y[i] series to which the driving signals of the touch sensor panel are inputted, electrode lines of X[j] series, that is, signals coupled to the reception unit or the first reception unit, and mutual capacitance C_{M} between the electrode lines of Y[i] series and the electrode lines of X[j] series.

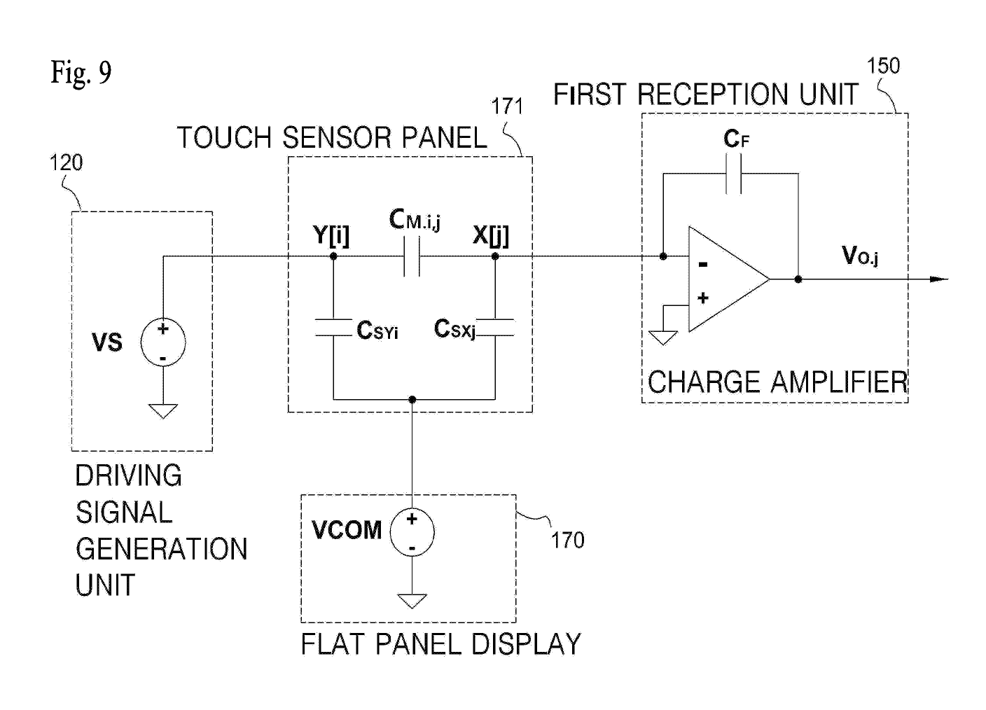

FIG. 9 shows a conventional capacitive touch sensing apparatus. In such a conventional capacitive touch sensing apparatus, a touch sensor circuit is coupled to a capacitive touch sensor panel, and whether or not a touch is present and a touched position are determined by measuring mutual capacitance C_{M} between two lines that cross each other. In FIG. 9, self-capacitance C_{SXj} coupled to an electrode X[j], self-capacitance C_{SXj} coupled to an electrode Y[i], and self-capacitance C_{SYi} coupled to the electrode Y[i] indicate capacitances that are formed with the terminal of an LCD common electrode VCOM when the electrode X[j] and the electrode Y[i] of FIG. 8 are an LCD.

The mutual capacitance C_{M,i,j} of FIG. 9 is capacitance between the electrode Y[i] and the electrode X[j] of FIG. 8. A driving signal VS is applied to the electrode Y[i], and the electrode X[j] is coupled to the input terminal of the first reception unit 150.

In FIG. 9, the driving signal VS is a sine waveform signal or a pulse waveform signal whose frequency and amplitude have a constant value in relation to time, and the first reception unit 150 includes a charge amplifier.

In FIG. 9, assuming that the gain of an operational amplifier used in the charge amplifier is infinity, the output signal V_{O,j}(s) of the first reception unit 150 is represented by Equation 6 below in an s-domain region.

$${V}_{O \cdot j} ( s ) = - \frac{{C}_{M \cdot i , j}}{{C}_{F}} \cdot VS ( s ) - \frac{{C}_{SXj}}{{C}_{F}} \cdot VCOM ( s ) \qquad [ Equation 6 ]$$

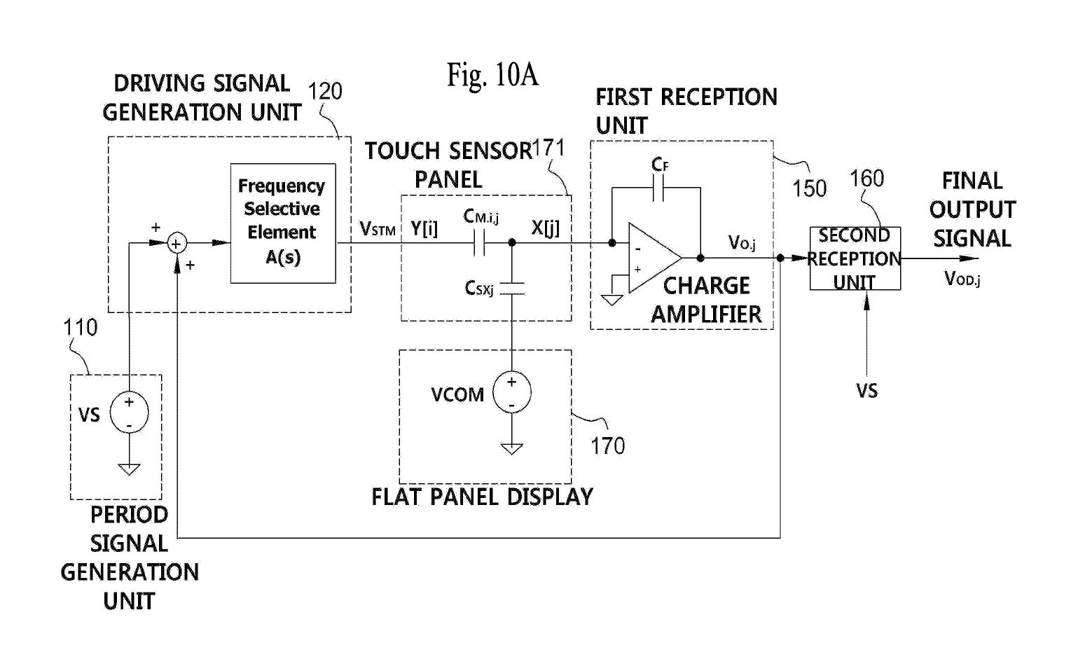

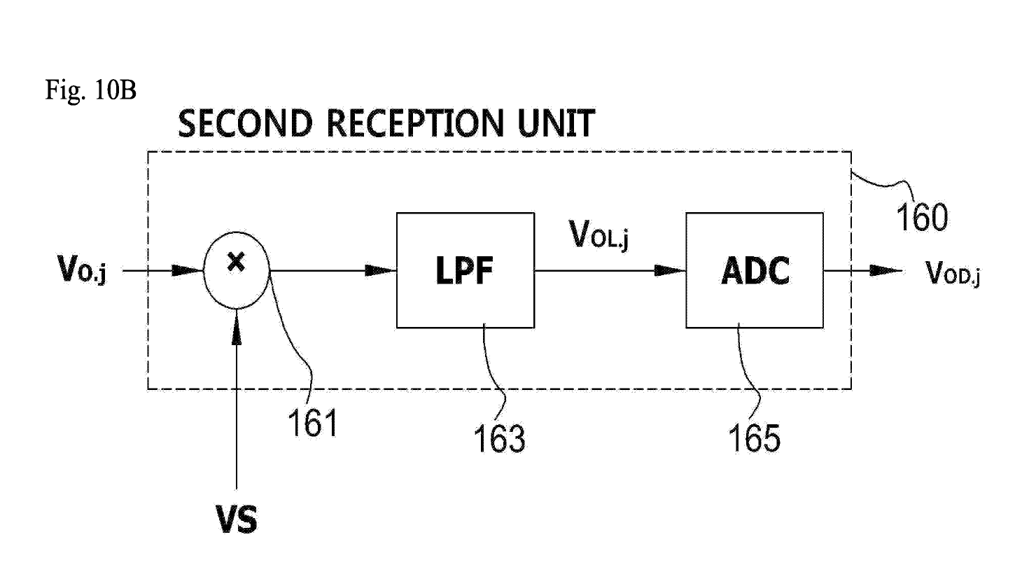

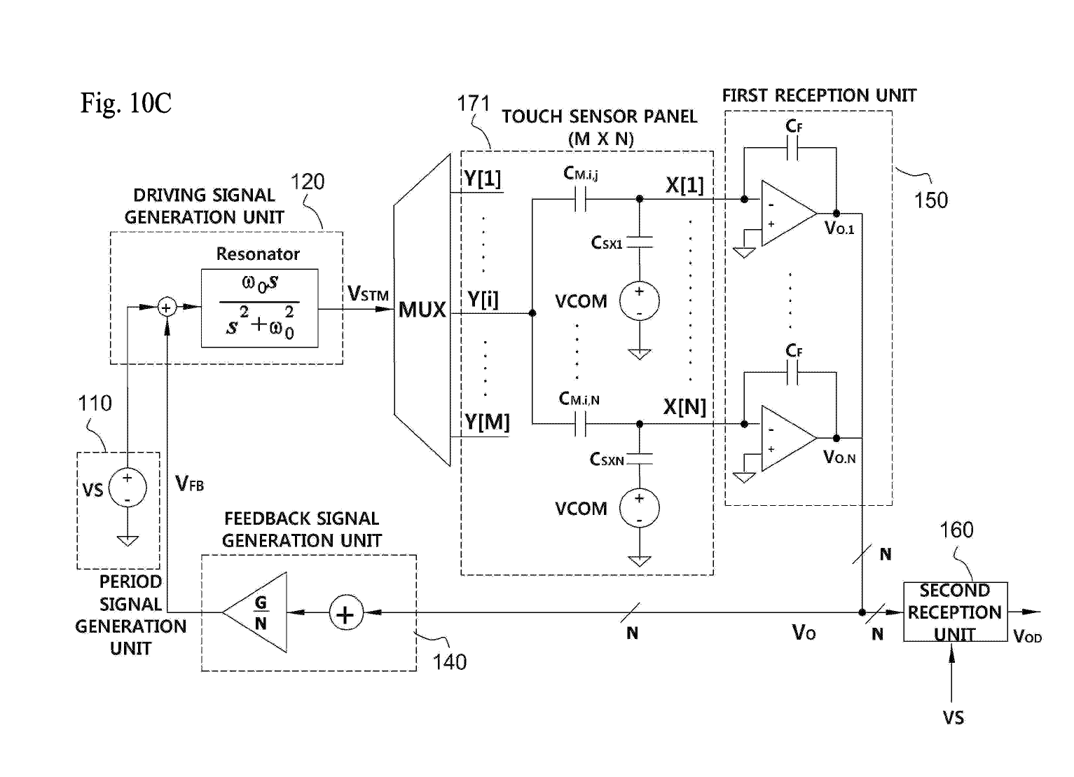

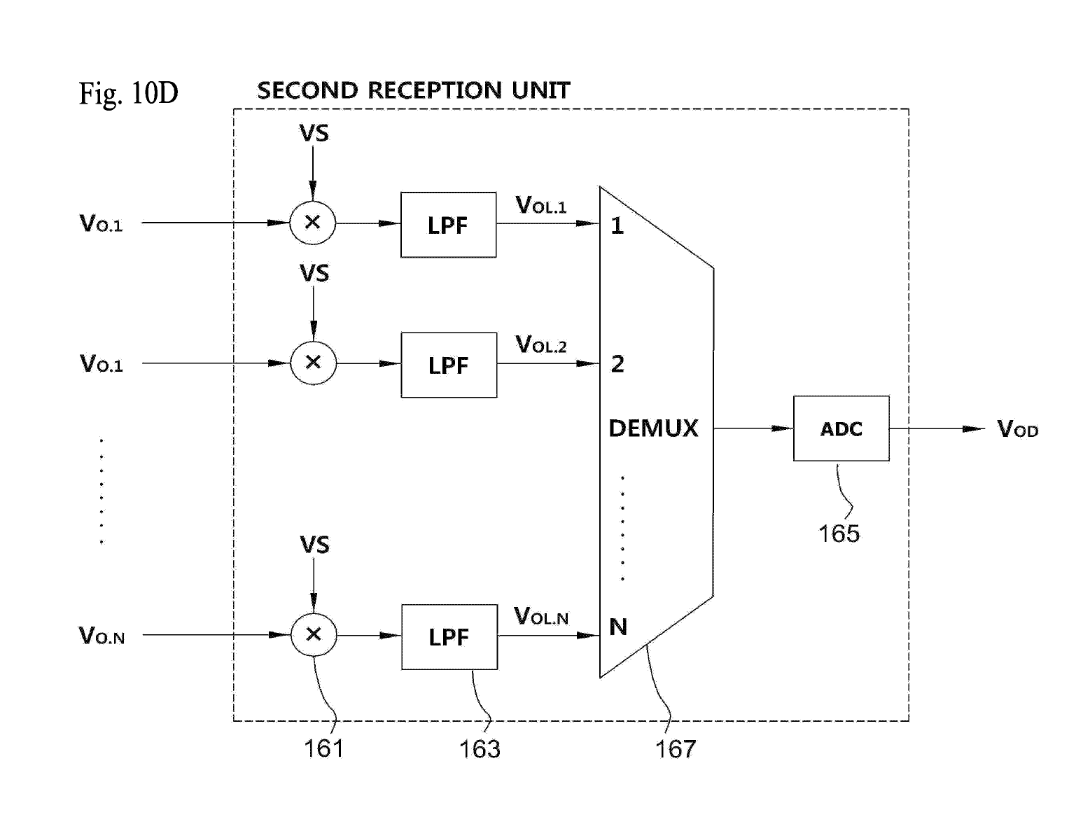

FIG. 10A shows a capacitive touch sensing apparatus in accordance with the present invention. The capacitive touch sensing apparatus of FIG. 10A is different from the conventional capacitive touch sensing apparatus of FIG. 9 in that the frequency and amplitude of the driving signal VS of the touch sensor shown in FIG. 9 maintain a constant value in relation to time, whereas the frequency and amplitude of the driving signal V_{SIM} of the touch sensor shown in FIG. 10A are changed in relation to time. In FIG. 10A, since the driving signal generation unit 120, the touch sensor panel 171, and the first reception unit 150 form one negative feedback loop, noise (VCOM noise, etc.) applied to the touch sensor panel 171 is reduced by (1+loop gain) times, and reduced noise appears in the output terminal. Assuming that the gain of an operational amplifier used in the charge amplifier of the first reception unit 150 is infinity, the output signal V_{O,j}(s) of the first reception unit 150 is represented by Equation 7 below.

$${V}_{O \cdot j} ( s ) = \frac{- \frac{{C}_{M \cdot i , j}}{{C}_{F}} A ( s )}{1 + \frac{{C}_{M \cdot i , j}}{{C}_{F}} A ( s )} VS ( s ) + \frac{- \frac{{C}_{SXj}}{{C}_{F}}}{1 + \frac{{C}_{M . i , j}}{{C}_{F}} A ( s )} VCOM ( s ) \qquad [ Equation 7 ]$$

In FIG. 10A, the driving signal generation unit 120 includes an adder and a frequency selective element. The frequency selective element is an element whose transfer function A(s) is changed in response to a signal frequency. In FIG. 10A, if the voltage gain of the operational amplifier included in the charge amplifier is infinity, a loop gain value is A(s)(C_{M,i,j}/C_{P}).

The frequency selective element A(s) can be configured using a resonator. Here, ‘s’ is identical with jω (wherein j=\sqrt{−1}). Accordingly, in the resonant frequency jω of the resonator or the signal frequency ω close to the signal frequency ω, a value A(jω) is much greater than 1. If the signal frequency ω becomes distant from the resonant frequency ω_{O}, the value A(jω) becomes smaller than 1. The frequency of the input signal VS(s) of the driving signal generation unit 120 shown in FIG. 10A is made identical with the resonant frequency ω_{O} of the resonator. In this case, an equation for the output signal V_{0,j} of the first reception unit 150 is shown in Equation 8.

$${V}_{O \cdot j} ( {jω}_{0} ) \approx - VS ( {jω}_{0} ) - \frac{{C}_{SXj}}{{C}_{F}} \cdot \frac{1}{A ( {jω}_{0} )} \cdot VCOM ( {jω}_{0} ) \qquad [ Equation 8 ]$$

In general, in a touch sensor panel, mutual capacitance C_{M,i,j} is about 1 pF, self-capacitance C_{SXj} has a value of 20 pF or more, and C_{F} of the charge amplifier has a greater value than When comparing Equation 6 and Equation 8 with each other, in the present invention (Equation 8), a gain value for the input signal VS is increased to 1 in C_{M,i,j}/C_{F}, and a gain value for VCOM noise is greatly reduced by A(jω_{O}) times. Accordingly, in the touch sensor circuit of the present invention, if the frequency of the input signal VS is made identical with the resonant frequency ω₀ of the resonator or made become close to the resonant frequency ω₀, VCOM noise rarely appears in the output voltage V_{O,j} of the first reception unit 150. In Equation 8, however, since mutual capacitance C_{M,i,j} to be measured does not appear in the output signal V_{O,j}, a signal proportional to the mean value of the output signals of all charge amplifiers is generated and used as the input signal of the driving signal generation unit 120 of FIG. 10A without using only the output signal V_{O,j} of one charge amplifier. This is described in detail with reference to FIG. 10C later. A second reception unit 160 receives the output signal V_{O,j} from the first reception unit 150 and outputs a DC or low frequency signal as its final output signal.

One of embodiments in which the second reception unit 160 is implemented is that a Low-Pass Filter (LPF) is coupled to the rear of a multiplier (or a chopper) in series, thus generating a signal V_{OL,j} obtained by extracting the frequency of the input signal VS or only signal components close to the frequency of the input signal VS and the signal V_{OL,j} is converted into a digital (V_{OD,j}) signal through an Analog-to-Digital Converter ADC, as shown in FIG. 10B. The second reception unit 160 of FIG. 10B is also commonly used in conventional touch sensors. When comparing an example in which the second reception unit 160 of FIG. 10B is used in the touch sensor circuit of FIG. 10A in accordance with the present invention with an example in which the conventional touch sensor circuit of FIG. 9 is coupled to the second reception unit 160 of FIG. 10B in series, the SNR of the final output signal is greatly increased in the example of the present invention. Equation 9 and Equation 10 show the SNRs of the two examples.

$$\begin{matrix}SNR ( conventional ) = 20 {log}_{10} \{ \frac{{C}_{M . i , j}}{{C}_{SXj}} \frac{VS ( jω )}{VCOM ( jω )} \} & [ Equation 9 ] \\ SNR ( this invention ) = 20 {log}_{10} \{ A ( {jω}_{0} ) \frac{{C}_{F}}{{C}_{SXj}} \frac{VS ( {jω}_{0} )}{VCOM ( {jω}_{0} )} \} & [ Equation 10 ]\end{matrix}$$

From Equation 9, it can be seen that the amplitude of the input signal VS needs to be increased in order to increase an SNR value in the conventional touch sensor circuit. When comparing Equation 9 and Equation 10 with each other, an SNR value is increased by 20log₁₀{A(jω_{O})C_{F}/C_{SXj}} [dB] in the present invention. Accordingly, if the gain value A(jω_{O}) of the resonator is increased, a sufficiently high SNR value can be obtained even without increasing the amplitude of the input signal VS.

In the touch sensing apparatus of FIG. 10A in accordance with the present invention, if an M×N touch sensor panel is used, the driving signal V_{STM} has been illustrated as being generated using only one output V_{O,j} of N charge amplifiers. In reality, however, the driving signal V_{STM} is generated using all the output signals of the N charge amplifiers. To this end, as shown in FIG. 10C, in order to generate the feedback signal V_{FB} used in the driving signal generation unit 120 using all the output signals V_{O.1}, V_{O.2}, . . . , V_{O.N} of the N charge amplifiers, a feedback signal generation unit 140 is added. Furthermore, as shown in FIG. 10C, in order to sequentially apply the driving signal V_{STM}, that is, the output signal of the driving signal generation unit 120, to one of M touch sensor panel electrodes, an 1-to-M multiplexer MUX is used. FIG. 10C shows an example in which the driving signal V_{STM} is applied to an i^{th} electrode Y[i], that is, one of the M touch sensor panel electrodes, and N electrodes X[1], X[2], . . . X[N] extending in a vertical direction to the i^{th} electrode Y[i] are coupled to respective charge amplifiers. The electrode Y[i] and the electrode X[j] are electrically coupled by mutual capacitance C_{M,i,j}.

The feedback signal V_{FB}, that is, the output signal of the feedback signal generation unit 140, is generated in proportion to N input signals (i.e., the mean value of the output signals of the charge amplifiers). This is because if the feedback signal generation unit 140 generates the feedback signal V_{FB} using the output of one first reception unit 150 corresponding to j^{th}, a change of j^{th} mutual capacitance to be measured in the resonant frequency ω_{O} of the resonator rarely appears in the output V_{O,j} of the first reception unit 150 as in Equation 8. In order to solve this problem, the feedback signal generation unit 140 generates the feedback signal V_{FB} by averaging the output values of the N first reception units 150. In this case, the output voltage V_{O.j}(s) of the first reception unit 150 using the electrode X[j] as input becomes Equation 11, and an output voltage V_{O.j}(jω_{O}) in the resonant frequency ω_{O} of the resonator becomes Equation 12. As a result, an input signal VS(jω_{O}) is multiplied by a change of the j^{th} mutual capacitance C_{M,i,j}, and a result of the multiplication appears in the output voltage V_{O.j}(jω_{O}) of the first reception unit 150. Accordingly, a change of the j^{th} mutual capacitance can be measured. In Equation 12, assuming that the frequency of the output signal of the period signal generation unit 110 is identical with the resonant frequency ω₀ of the resonator, if self-capacitance C_{SXk} is the same in all k values (k=1, 2, . . . , N) and mutual capacitance C_{M,i,j} is the same in all j values (j=1, 2, . . . , N), VCOM noise does not appear in the output voltage V_{O.j}(jω_{O}) of the first reception unit 150.

$$\begin{matrix}{V}_{O \cdot j} ( s ) = \frac{- \frac{{C}_{M . i , j}}{{C}_{F}} A ( s )}{1 + \frac{G}{N} ( {\sum }_{k = 1}^{N} {C}_{M \cdot i , k} / {C}_{F} ) A ( s )} VS ( s ) + \frac{- \frac{{C}_{SXj}}{{C}_{F}} + \frac{GA ( s )}{{C}_{F}^{2} N} \{ {C}_{M \cdot i , j} {\sum }_{k = 1}^{N} {C}_{SXk} - {C}_{SXj} {\sum }_{k = 1}^{N} {C}_{M \cdot i , k} \}}{1 + \frac{G}{N} A ( s ) \frac{1}{{C}_{F}} {\sum }_{k = 1}^{N} {C}_{M \cdot i , k}} VCOM ( s ) & [ Equation 11 ] \\ {V}_{O \cdot j} ( {jω}_{0} ) = \frac{- {C}_{M \cdot i , j}}{\frac{G}{N} ( {\sum }_{k = 1}^{N} {C}_{M \cdot i , k} )} VS ( {jω}_{0} ) + \frac{\{ {C}_{M \cdot i , j} \cdot {\sum }_{k = 1}^{N} {C}_{SXk} - {C}_{SXj} \cdot {\sum }_{k = 1}^{N} {C}_{M \cdot i , k} \}}{{C}_{F} \cdot {\sum }_{k = 1}^{N} {C}_{M \cdot i , k}} VCOM ( {jω}_{0} ) & [ Equation 12 ]\end{matrix}$$

The second reception unit 160 of FIG. 10C generates the final output signal V_{OD} using [symbol] the output signal V_{O.1}, V_{O.2}, . . . , V_{O.N} of the first reception unit 150 and the output signal VS of the period signal generation unit 110 as input. Another embodiment of a detailed circuit that implements the second reception unit 160 is shown in FIG. 10D. Each of the output signals V_{O.1}, V_{O.2}, . . . , V_{O.N} of the N first reception units 150 is multiplied by the output signal VS of the period signal generation unit 110 using a multiplier or a chopper circuit 161, and a result of the multiplication passes through a Low-Pass Filter (LPF) 163. In such a case, only components of the output signal components of the first reception units 150, having the same frequency and phase as the output signal VS of the period signal generation unit 110, are outputted as the output signals of the LPF 163, and components due to noise induced from a touch sensor panel do not appear in the output of the LPF 163. In FIG. 10D, the output signals V_{OL.1}, V_{OL.2}, . . . V_{OL.N} of N LPFs are slow signals close to DC. Accordingly, the output signals of the N PPFs pass through a demultiplexer DEMUX 167 and then converted into a digital signal through one ADC 165 in accordance with a time multiplexing method.

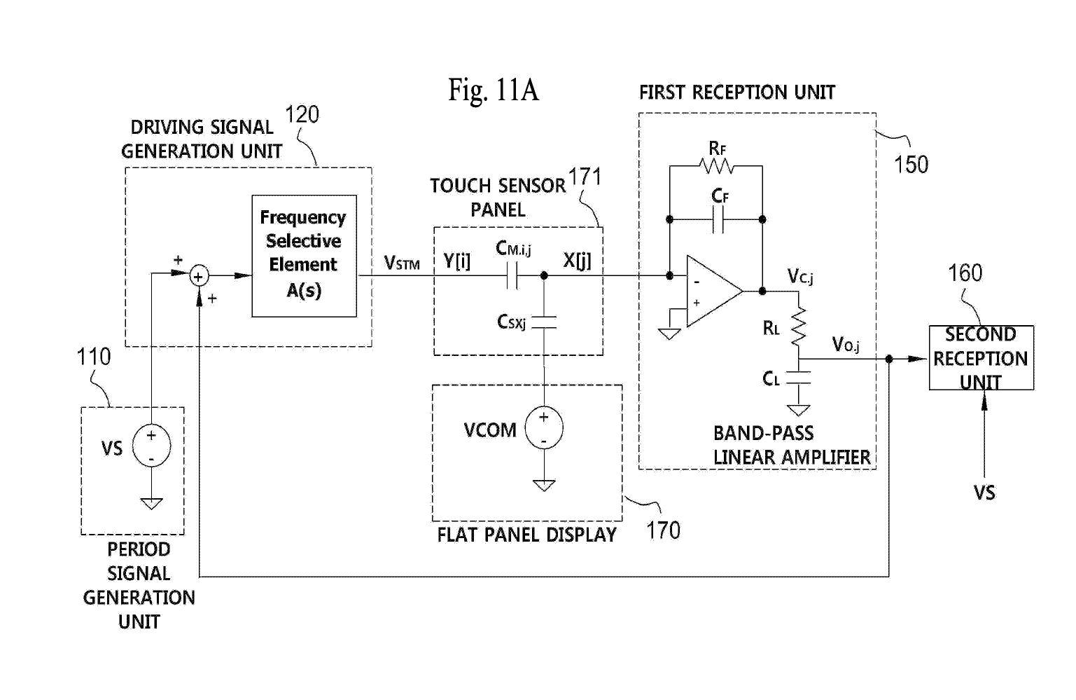

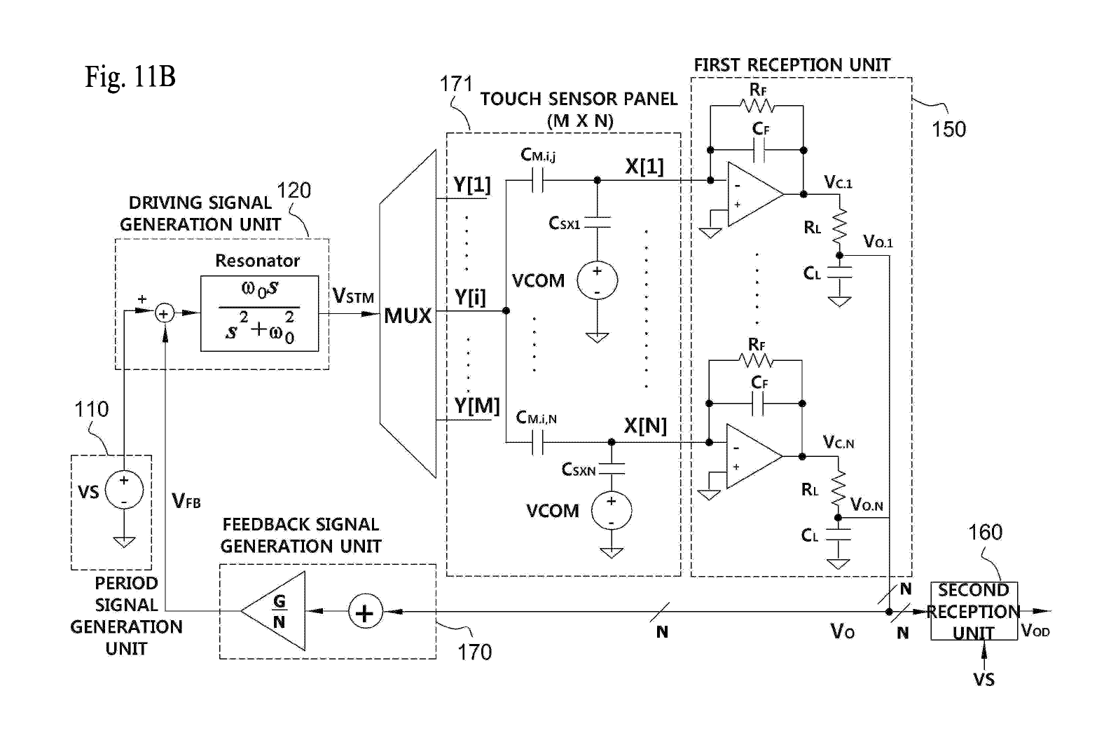

The output voltage V_{O.j} of the charge amplifier of the first reception unit 150 shown in FIG. 10A is given as the sum of −(C_{M,i,j}/C_{F})*V_{STM} and −(C_{SKj}/C_{F})*VCOM. Here, self-capacitance C_{SXj} of the touch sensor panel 171 is commonly several tens of pF, mutual capacitance C_{M,i,j} is about 1 pF, and the driving signal V_{STM} of the touch sensor panel 171 and flat panel display noise VCOM have an almost similar amplitude. Accordingly, it is not easy to saturate the operating output voltage of the amplifier that forms the charge amplifier because a value ‘−(C_{SXj}/C_{F})*VCOM’ is much greater than a value ‘−(C_{M,i,j}/C_{F})*V_{STM}’. In this case, the SNR value of the output signal of the charge amplifier is reduced because the driving signal V_{STM} of the touch sensor panel 171 does not appear as a value that is precisely proportional to the output of the charge amplifier. In order to solve such a problem, the charge amplifier of FIG. 10A is changed into a band-pass filter form shown in FIG. 11. The conventional charge amplifier of FIG. 10A includes the operational amplifier, C_{M,i,j} and C_{F} and operates as a linear amplifier (gain stage). In contrast, the charge amplifier of a band-pass filter form shown in FIG. 11 operates as a band-pass linear amplifier. The band-pass linear amplifier includes the resonant frequency of a resonator in a pass band. Thus, a frequency component not included in the pass band of the band-pass linear amplifier, of the frequency components of flat panel display noise VCOM, does not appear in the band-pass linear output voltage of the amplifier. Furthermore, a component close to the resonant frequency of a resonator, of the frequency components included in the pass band of the band-pass linear amplifier that belong to the frequency components of flat panel display noise VCOM, is removed by the operation of a negative feedback loop formed by the driving signal generation unit 120, the touch sensor panel, and the first reception unit 150 of FIG. 10A in accordance with the present invention, with the result that the components close to the resonant frequency of the resonator do not appear in the output of the band-pass linear amplifier. Accordingly, if the charge amplifier of a band-pass filter form in accordance with the present invention is used, the components of flat panel display noise VCOM do not appear in the output of the charge amplifier in almost all frequency bands. As a result, if the charge amplifier of a band-pass filter form of FIG. 11 in accordance with the present invention is used, the SNR value of the output voltage of a charge amplifier can be increased because a phenomenon in which the operational amplifier is saturated is reduced.

In the band-pass linear amplifier circuit of FIG. 11, the output signal V_{O.j} of a first reception unit 150 has a band-pass characteristic in relation to a driving signal V_{STM} and flat panel display noise VCOM, but the output terminal voltage V_{C.j} of an operational amplifier has a high-pass characteristic in relation to the driving signal V_{STM} and the flat panel display noise VCOM. Accordingly, voltage at the output terminal of the operational amplifier can be saturated because the high frequency component of the VCOM is amplified by the high-pass characteristic without being attenuated and thus the high frequency component remains as voltage V_{C,j} at the output terminal of the operational amplifier. If an ideal operational amplifier is used, transfer functions for the V_{STM} of the voltage V_{C,j} and the output signal V_{O,j} and the VCOM are shown in Equations 13 and 14, respectively.

$$\begin{matrix}{V}_{C \cdot j} ( s ) = - \frac{{sR}_{F} {C}_{M \cdot i , j} \cdot {V}_{STM} ( s ) + {sR}_{F} {C}_{SXj} \cdot VCOM ( s )}{1 + {sR}_{F} {C}_{F}} & [ Equation 13 ] \\ {V}_{O \cdot j} ( s ) = - \frac{{sR}_{F} {C}_{M \cdot i , j} \cdot {V}_{STM} ( s ) + {sR}_{F} {C}_{SXj} \cdot VCOM ( s )}{( 1 + {sR}_{F} {C}_{F} ) \cdot ( 1 + {sR}_{L} {C}_{L} )} & [ Equation 14 ]\end{matrix}$$

If an operational amplifier having a more realistic single pole frequency characteristic is used, transfer functions for the V_{STM} of the voltage V_{C,j} and the output signal V_{O,j} and the VCOM are shown in Equations 15 and 16, respectively. It is assumed that the operational amplifier has a voltage gain of GBW/s. Here, ‘s’ is a Laplace parameter and GBW is each frequency at which a voltage gain value of the operational amplifier becomes 1. The transfer function of V_{C,j} has a band-pass characteristic by way of the frequency characteristic of the operational amplifier. Accordingly, voltage at the output terminal of the operational amplifier is not saturated because the high frequency component of the VCOM is attenuated and thus attenuated voltage appears voltage at the output terminal of the operational amplifier. ωₙ and a damping factor ζ used in Equations 15 and 16 are shown in Equations 17 and 18.

$$\begin{matrix}{V}_{C \cdot j} ( s ) = - \frac{GBW}{{R}_{F} ( {C}_{F} + {C}_{SXj} + {C}_{M \cdot i , j} )} \cdot \frac{{sR}_{F} {C}_{M \cdot i , j} \cdot {V}_{STM} ( s ) + {sR}_{F} {C}_{SXj} \cdot VCOM ( s )}{{s}^{2} + 2 {ζω}_{n} s + {ω}_{n}^{2}} & [ Equation 15 ] \\ {V}_{O \cdot j} ( s ) = \frac{{V}_{C \cdot j} ( s )}{1 + {sR}_{L} {C}_{L}} & [ Equation 16 ] \\ {ω}_{n} = \sqrt{\frac{GBW}{{R}_{F} ( {C}_{F} + {C}_{SXj} + {C}_{M \cdot i , j} )}} & [ Equation 17 ] \\ ζ = \frac{1 + {R}_{F} {C}_{F} GBW}{2 \sqrt{{R}_{F} ( {C}_{F} + {C}_{M \cdot i , j} + {C}_{SXj} ) GBW}} & [ Equation 18 ]\end{matrix}$$

As shown in Equation 15, in the present invention, the transfer function of the output signal V_{O,j} of the first reception unit 150 is made to have a band-pass characteristic and the resonant frequency ωₒ of the resonator is placed in the pass band of the transfer function V_{O,1} by controlling the values R_{F}, C_{F}, R_{L}, and C_{L}. Furthermore, the transfer function of the output terminal voltage V_{C,j} of the operational amplifier as well as the transfer function of the output signal V_{O,j} is made to have a band-pass characteristic by controlling the gain bandwidth product GBW of the operational amplifier. Accordingly, a phenomenon in which the output terminal voltage V_{C,j} of the operational amplifier is saturated by the high frequency component of the VCOM can be prevented.

FIG. 11B is a circuit in which the charge amplifiers of the N first reception units 150 shown in FIG. 10C are replaced with respective band-pass linear amplifiers shown in FIG. 11 in order to prevent a phenomenon in which the output terminal voltage V_{C,j} of the operational amplifier is saturated.

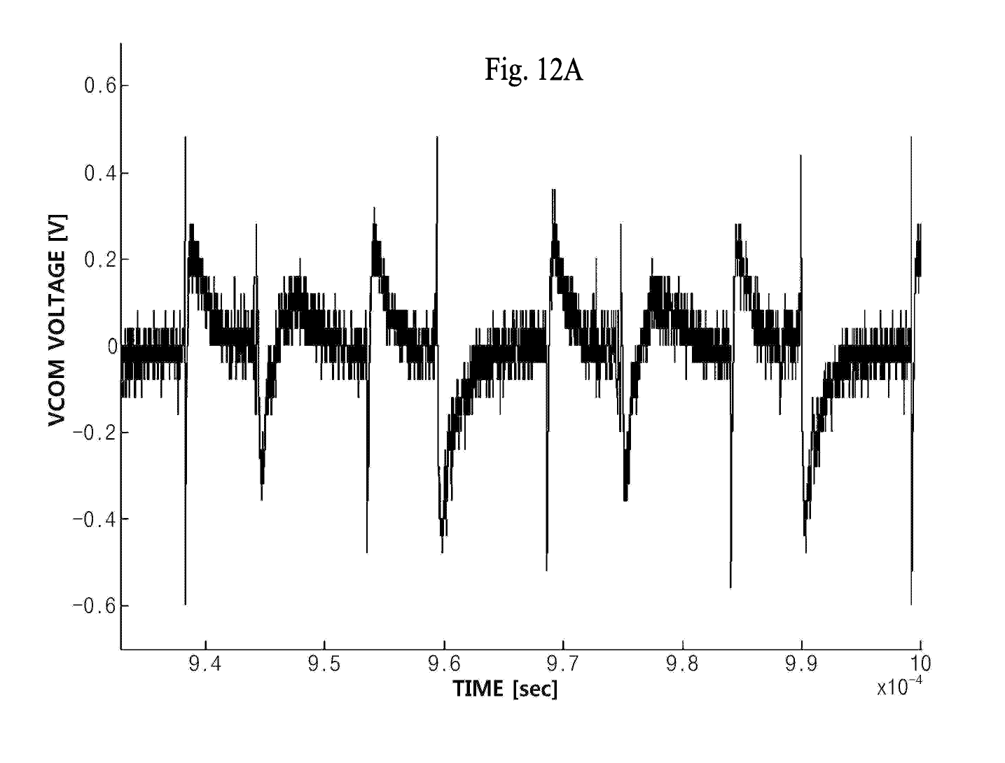

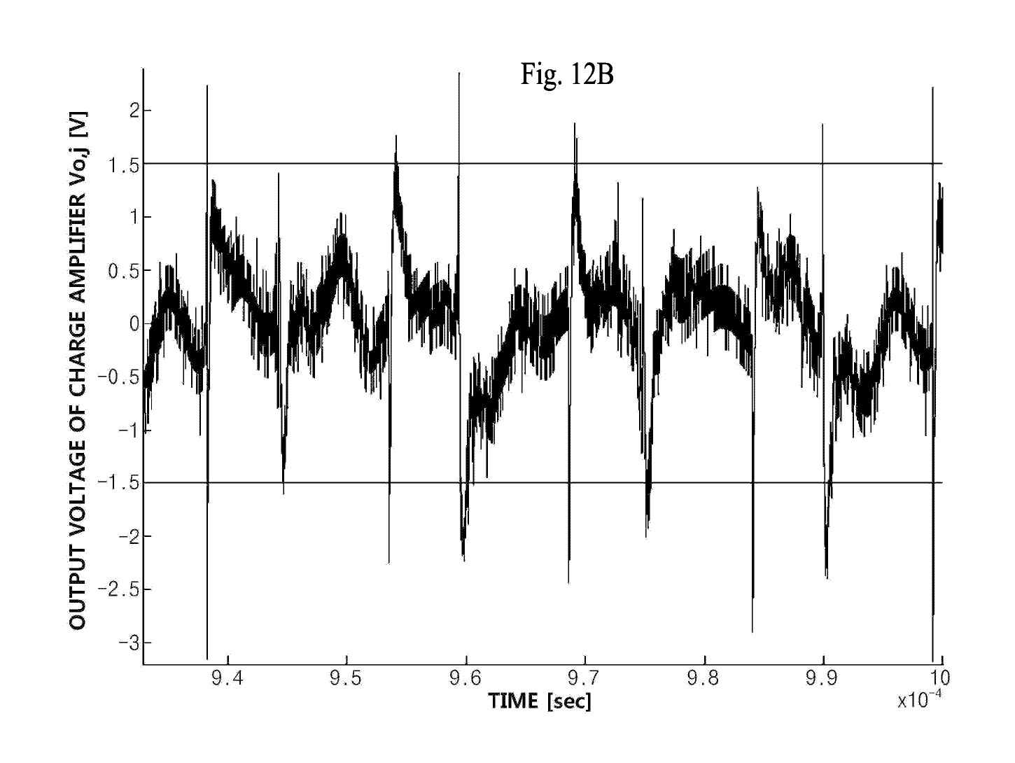

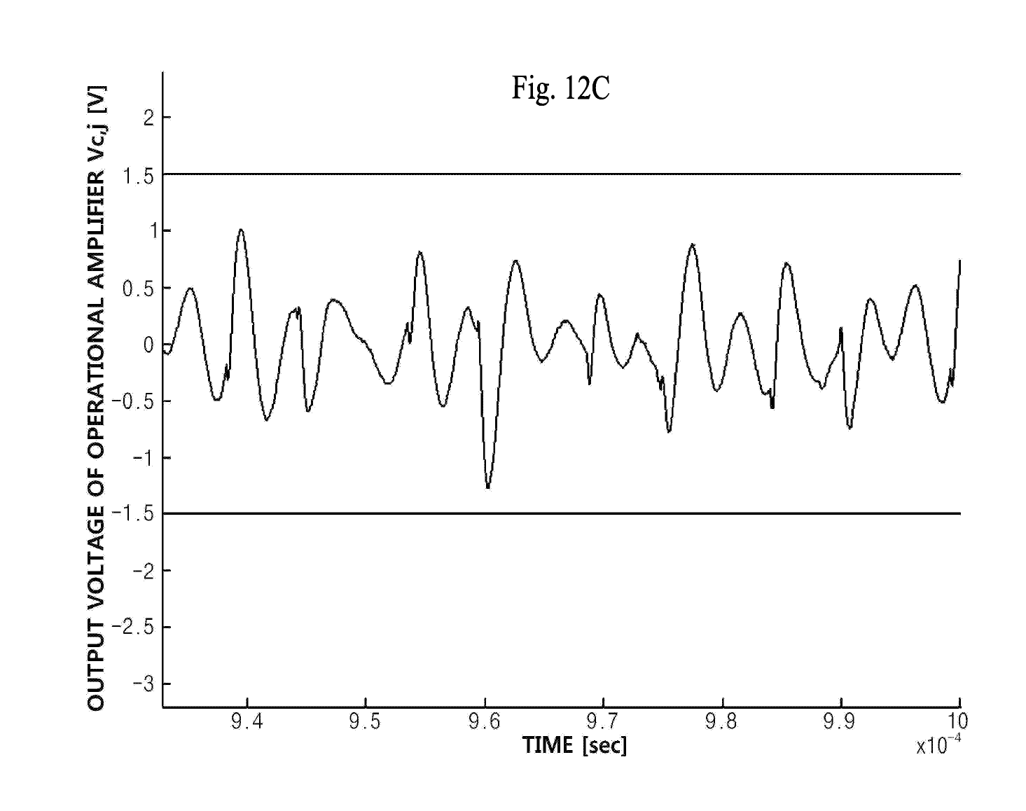

A waveform of flat panel display noise VCOM used in the present invention is shown in FIG. 12A. The waveform was extracted from data that was measured at the terminal of VCOM which is shown in FIG. 5 of a real LCD panel. In order to monitor the effects of the band-pass linear amplifier shown in FIG. 11 regarding the phenomenon in which voltage at the output terminal of the operational amplifier is saturated, a waveform of the output terminal V_{O.j} of the charge amplifier which does not have the band-pass function of FIG. 10A in accordance with the present invention and a waveform of the output terminal V_{C,j} of the operational amplifier included in a charge amplifier to which the band-pass function of FIG. 11 has been added are shown in FIGS. 12B and 12C, respectively. In FIG. 12B, it was assumed that the operational amplifier is an ideal operational amplifier whose gain is infinity, and in FIG. 12C, the operational amplifier has a finite voltage gain, a single pole characteristic, a bandwidth of 1.3 kHz, and a gain-bandwidth product GBW of 1.3 MHz. The output terminal of the operational amplifier shown in FIG. 12B has a maximum voltage value of 2.36 V and a minimum voltage value of −3.11 V. Furthermore, the output terminal of the operational amplifier voltage shown in FIG. 12C has a maximum voltage value of 1.01 V and a minimum voltage value of −1.28 V. The output terminals of the operational amplifiers of FIGS. 12B and 12C have peak-to-peak voltage values of 5.47 V and 2.29 V. Accordingly, it can be seen that a phenomenon in which voltage at the output terminal of the operational amplifier voltage can be improved if the charge amplifier having a band-pass function is used as in FIG. 12C.

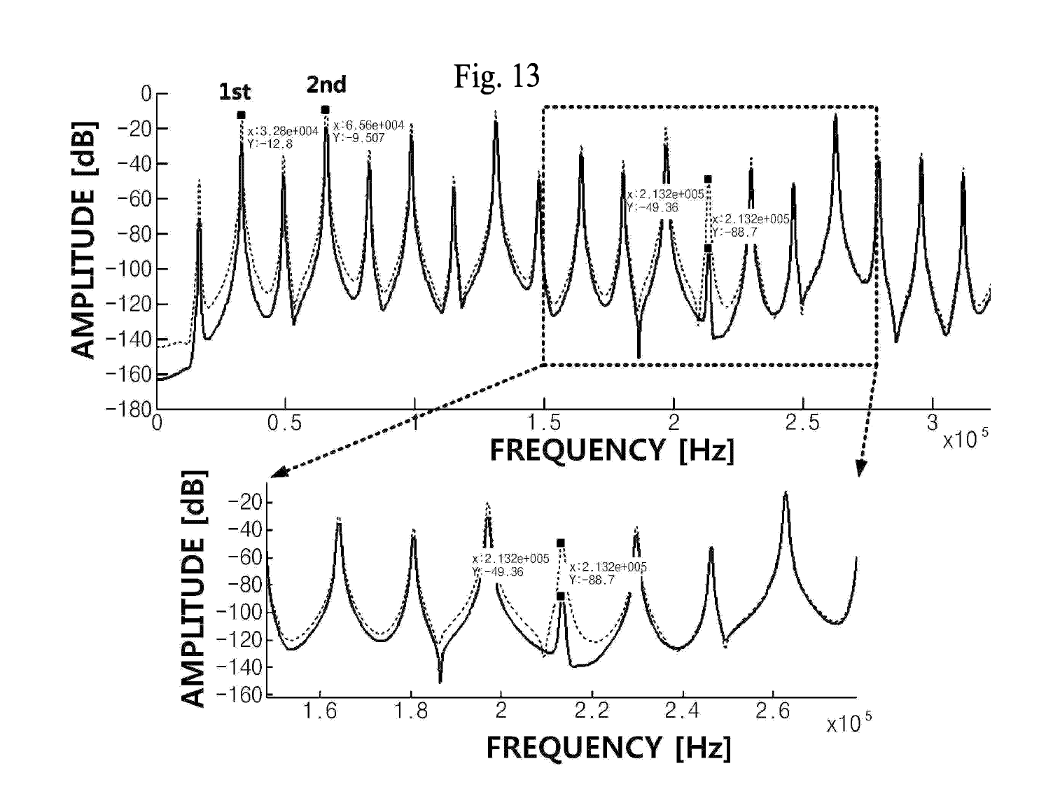

FIG. 13 shows a comparison between the frequency spectra of the output signals of the conventional capacitive touch sensing apparatus shown in FIG. 9 and of the touch sensing apparatus in accordance with the present invention (i.e., the output voltage V_{O,j} of the first reception unit 150 of FIG. 11). A dotted line and a solid line in FIG. 13 indicate the frequency spectra of the conventional capacitive touch sensing apparatus of FIG. 9 and the touch sensing apparatus of FIG. 11 in accordance with the present invention. In order to monitor only the influence of flat panel display noise VCOM, both the output VS of the driving signal generation unit 120 of FIG. 9 and the output VS of the period signal generation unit 110 of FIG. 10A were set to 0. The resonant frequency of the driving signal generation unit 120 shown in FIG. 11 was set to 213 kHz. If the LPF of the second reception unit 160 shown in FIG. 10D has a bandwidth of 3 kHz, the output voltage of the first reception unit 150 needs to be less influenced by the flat panel display noise VCOM in frequency bands of 210 kHz and 216 kHz. From FIG. 13, it can be seen that the influence of the flat panel display noise VCOM in the output voltage of the first reception unit 150 of the touch sensor circuit shown in FIG. 11 in accordance with the present invention is reduced by 40 dB as compared with the conventional touch sensor circuit of FIG. 9.

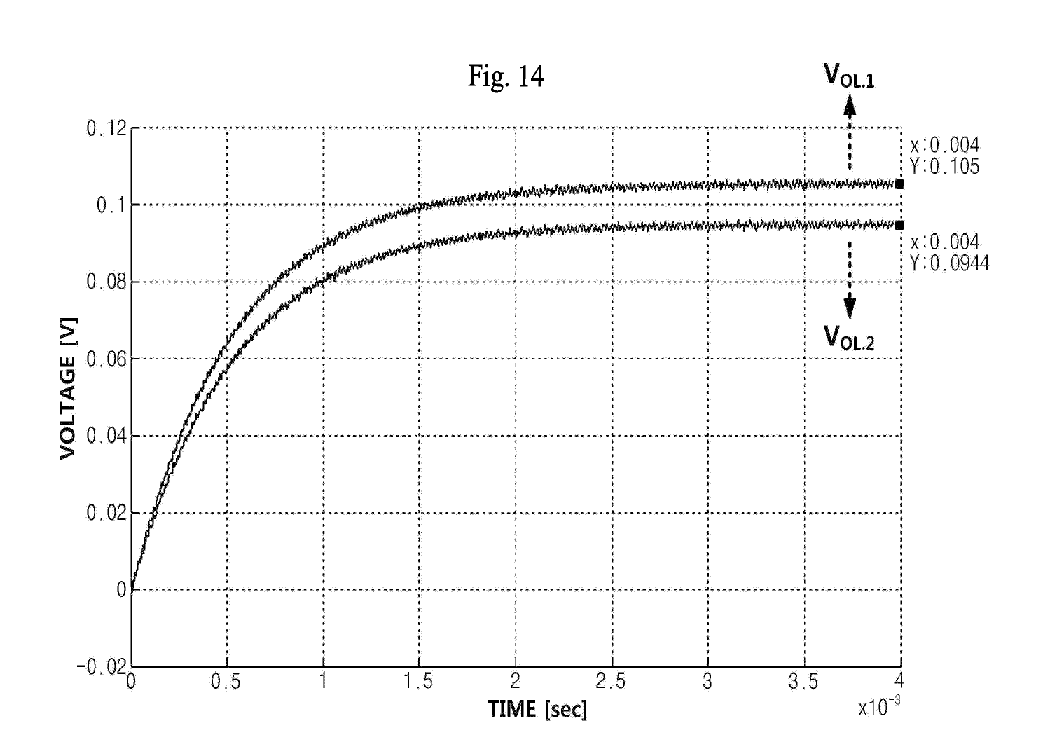

FIG. 14 shows an example in which the driving signal V_{STM} is applied to only the electrode Y[1] of the touch sensor panel of the touch sensing apparatus shown in FIG. 11B in accordance with the present invention and waveforms of the output signals (i.e., V_{OL.1} and V_{OL.2} in FIG. 10D) of the low-pass filter of the second reception unit 160 in a reception circuit (i.e., the first reception unit 150+the second reception unit 160) to which respective electrodes X[1] and X[2] are coupled. Assuming that a touch operation had been performed only at the cross point of an electrode Y[1] and an electrode X[1] in the touch sensor panel, a value of mutual capacitance C_{M.1,1} between the electrode Y[1] and the electrode X[1] was set to 1.35 pF and a value of mutual capacitance C_{M.1,2} between the electrodes Y[1] and X[2] was set to 1.5 pF. Furthermore, values of self-capacitances (i.e., C_{SX.1} and C_{SX.2} in FIG. 12) of the electrodes X[1] and X[2] were set to 20 pF. The waveform shown in FIG. 12A was used as the waveform of the flat panel display noise VCOM shown in FIG. 11B, the resonator of the driving signal generation unit 120 had a resonant frequency of 213 kHz, the output signal VS of the period signal generation unit 110 had a frequency of 213 kHz, a sine wave having an amplitude of 0.2 V was used, and the LPF of the second reception unit 160 had a bandwidth of 3 kHz. In this case, it could be seen that after the output voltages V_{OL.1} and V_{OL.2} of the low-pass filter of the second reception unit 160 was stabilized, the amount of the output voltage V_{OL.1} was 105 mV and the amount of the output voltage V_{OL.2} was 94 mV. Accordingly, it could be seen that the output voltage was decreased at the same ratio at which mutual capacitance was reduced and thus whether a touch is present or not could be determined.

A detailed embodiment to which the present invention may be applied has been described about in a touch sensing apparatus for determining whether or not a touch is present in a behavior of a user. Accordingly, it is evident to those skilled in the art that the present invention should not be limitedly applied to only a sensing apparatus using a touch method, but can be applied to all sensing apparatuses for generating a driving signal using a periodic input signal and a feedback signal. It is therefore to be noted that such applications may fall within the scope of the present invention in accordance with the claims of the present invention.

Furthermore, the technical spirit of the present invention can be applied to all sensing apparatuses for recognizing a change of physical quantity, such as a change of capacitance and a change of inductance, in response to a behavior of a user.

It is also to be noted that any one of several elements that form the circuit of the present invention, for example, the period signal generation unit 110, the driving signal generation unit 120, the reception unit, and the feedback signal generation unit 140 may be properly distributed over several integrated circuit chip depending on an intension of a circuit designed. Such a modification is also included in the present invention, and it does not violate the technical spirit of the present invention.

In accordance with the search workers of the present invention, the level of fabrication technology of a recent semiconductor integration circuit and the simulations results of a circuit operation based on the level of fabrication technology have revealed that the semiconductor integrated circuit chip could operate at a power source voltage of 4 V or less with no great problem and also operate even without an additional boosting circuit. Accordingly, it was verified that a touch sensor panel can be driven by only an integrated circuit chip.

Meanwhile, a square wave or a triangle wave in addition to a sine wave may also be used as the period signal generated from the period signal generation unit 110.

As is apparent from the above description, the sensor circuit in accordance with the present invention can maintain the SNR of the final output signal of the sensor circuit at a relatively high value while maintaining an input signal, applied to the sensor element, at a relatively small amplitude value in such a manner that the influence of noise induced from the sensor element is made rarely appear in the final output signal of the sensor circuit. Accordingly, there are advantages in that power consumption of a sensing apparatus chip can be reduced and a production cost for a sensing apparatus chip can be reduced by removing a high voltage driver. If the present invention is applied to a capacitive touch sensing apparatus using the mutual capacitance measurement method, the influence of common electrode (VCOM) noise generated from a flat panel display rarely appears in the final output signal of the capacitive touch sensing apparatus. Accordingly, there are advantages in that power consumption of a sensing apparatus chip can be reduced because the driving signal of a touch sensor panel can maintain a digital signal level without a need to increase the amplitude of the touch sensor panel and a production cost for a sensing apparatus chip can be reduced by removing a high voltage driver.

Furthermore, there is an advantage in that sensing speed can be enhanced because circuits within a sensing apparatus can be driven in the entire time domain in which a flat panel display device operates in addition to a blank (VBLANK) time interval in which the flat panel display device does not operate.

Although a preferred embodiment of the present invention has been described for illustrative purposes, those skilled in the art will appreciate that various modifications, additions and substitutions are possible, without departing from the scope and the spirit of the invention as disclosed in the accompanying claims.

1. A sensing apparatus, comprising:
a sensor element configured to recognize a behavior of a user or a movement of an object;
a first reception unit configured to operate in response to an output signal of the sensor element;
a second reception unit configured to operate in response to an output signal of the first reception unit;
a feedback signal generation unit configured to operate in response to the output signal of the first reception unit;
a period signal generation unit configured to generate a period signal; and
a driving signal generation unit coupled to an output signal of the period signal generation unit and an output signal of the feedback signal generation unit and configured to generate a sensor element driving signal.

2. The sensing apparatus of claim 1, wherein the period signal generation unit generates any one of a sine waveform, a pulse waveform, and a triangular waveform.

3. The sensing apparatus of claim 1, wherein the second reception unit comprises one or more of a multiplier and a chopper in order to reduce an influence of noise induced from the sensor element.

4. The sensing apparatus of claim 1, wherein the driving signal generation unit comprises a resonator.

5. The sensing apparatus of claim 1, wherein:
the first reception unit comprises a charge amplifier, and
the charge amplifier comprises an operational amplifier.

6. The sensing apparatus of claim 1, wherein the sensor element driving signal of the driving signal generation unit offsets some of noise signal components induced from the sensor element by a composition of a signal fed back from the sensor element and the output signal of the period signal generation unit.

7. The sensing apparatus of claim 4, wherein a frequency component having a range of 90% to 110% of a resonant frequency of the resonator, of frequency components of noise induced from the sensor element, is attenuated by a negative feedback operation.

8. The sensing apparatus of claim 1, wherein:
the sensor element comprises a variable sensor element 131 configured to receive the sensor element driving signal of the driving signal generation unit, generate an output signal whose value varies in response to physical quantity to be sensed, and transfer the generated output signal as an input signal of the first reception unit and a fixed sensor element 133 configured to receive the sensor element driving signal of the driving signal generation unit, generate an output signal whose value is constant irrespective of the physical quantity to be sensed, and transfer the generated output signal as the input signal of the first reception unit, and
a difference between an amount of a transfer function of the variable sensor element 131 and an amount of a transfer function of the fixed sensor element 133 in a resonant frequency of the resonator is 50% or less.

9. The sensing apparatus of claim 8, wherein the output signal of the variable sensor element 131 and the output signal of the fixed sensor element 133 have an identical frequency characteristic and time domain characteristic for noise induced in the variable sensor element 131 and the fixed sensor element 133.

10. The sensing apparatus of claim 8, wherein the first reception unit receives the output signal of the variable sensor element 131 and the output signal of the fixed sensor element 133, generate a first output signal determined in response to the output signal of the variable sensor element 131 and a second output signal determined in response to the output signal of the fixed sensor element 133, supplies the first output signal as the input signal of the second reception unit, and supplies the first output signal and the second output signal as the input signal of the feedback signal generation unit.

11. The sensing apparatus of claim 1, wherein a transfer function of the first reception unit has a frequency characteristic of a band-pass characteristic.

12. The sensing apparatus of claim 4, wherein the sensor element driving signal of the driving signal generation unit is offset in a frequency band having a range of 90% to 110% of a resonant frequency, of noise signal components induced from the sensor element.

13. The sensing apparatus of claim 1, wherein:
the second reception unit comprises a multiplication circuit configured to multiply some of the output signal of the first reception unit and the output signal of the period signal generation unit together and an integrator or a low-pass filter configured to have an input terminal coupled to an output signal of the multiplication circuit, and
the multiplication circuit comprises any one of a multiplier and a chopper circuit.

14. A sensing apparatus, comprising:
a flat panel display configured to comprise a touch sensor panel using a capacitive method of recognizing a touch operation;
a reception unit configured to operate in response to an output signal of the touch sensor panel;
a feedback signal generation unit configured to operate in response to an output signal of the reception unit;
a period signal generation unit configured to generate a period signal; and
a driving signal generation unit coupled to the output signal of the period signal generation unit and an output signal of the feedback signal generation unit and configured to generate a touch sensor panel driving signal.

15. The sensing apparatus of claim 14, wherein lines of the touch sensor panel in a first direction and lines of the touch sensor panel in a second direction are not electrically shorted.

16. The sensing apparatus of claim 14, wherein the touch sensor panel, together with the feedback signal generation unit, is included in an element that forms a feedback loop.

17. The sensing apparatus of claim 14, wherein the touch sensor panel driving signal of the driving signal generation unit for driving the touch sensor panel is changed using some of or the entire output signal of the reception unit.

18. The sensing apparatus of claim 14, wherein the touch sensor panel driving signal of the driving signal generation unit is applied to the touch sensor panel as a composite signal of the output signal of the feedback signal generation unit and the output signal of the period signal generation unit.

19. The sensing apparatus of claim 14, wherein the driving signal generation unit comprises a resonator.

20. The sensing apparatus of claim 14, wherein the period signal generation unit generates a sine waveform, a pulse waveform, or a triangular waveform.

21. The sensing apparatus of claim 14, wherein the reception unit comprises:
any one of a multiplier and a chopper circuit configured to have a signal, received from the touch sensor panel, coupled to an amplifier within the reception unit and to multiply an output signal of the amplifier and the output signal of the period signal generation unit together within the reception unit, and
any one of an integrator and a low-pass filter configured to receive an output signal of any one of the multiplier and the chopper circuit.

22. The sensing apparatus of claim 21, wherein:
the amplifier within the reception unit is a charge amplifier, and
an output signal of the amplifier is transferred as the input signal of the feedback signal generation unit.

23. The sensing apparatus of claim 19, wherein:
if a value of an input signal frequency inputted to the resonator shifts in a range of 90% to 110% of a resonant frequency, a transfer function value of the resonator is increased, and
if a value of the input signal frequency inputted to the resonator does not shift in a range of 90% to 110% of a resonant frequency, a transfer function value of the resonator is decreased.

24. The sensing apparatus of claim 19, wherein a frequency of the output signal of the period signal generation unit is greater than half a resonant frequency of the resonator and is smaller than twice the resonant frequency.

25. The sensing apparatus of claim 19, wherein:
a signal generated by combining the output signal of the period signal generation unit and the output signal of the feedback signal generation unit is applied to the resonator, and
an output signal of the resonator is applied to the touch sensor panel.

26. The sensing apparatus of claim 14, wherein the touch sensor panel driving signal of the driving signal generation unit is offset in a frequency band having a range of 90% to 110% of a resonant frequency, of noise signal components induced from the touch sensor panel.

27. The sensing apparatus of claim 25, wherein the touch sensor panel driving signal of the driving signal generation unit is offset in a frequency band having a range of 90% to 110% of a resonant frequency, of noise signal components induced from the touch sensor panel.

28. The sensing apparatus of claim 15, wherein noise generated from the flat panel display is common electrode (VCOM) noise of the flat panel display which is inputted to the reception unit through the touch sensor panel.

29. The sensing apparatus of claim 28, wherein:
a Noise Transfer Function (NTF) has a band-reject filter characteristic in which a transfer function value of the flat panel display is decreased when a frequency of a final output signal that is an output of the reception unit shifts in a range of 90% to 110% of a specific frequency and a transfer function value of the flat panel display is gradually increased when the frequency of the final output signal becomes distant from the specific frequency, and
the NTF is a ratio of noise components of the final output signal to the common electrode (VCOM) noise.

30. A sensing apparatus comprising an on-cell capacitive type touch sensor panel placed on a flat panel display for displaying an image or an in-cell capacitive type touch sensor panel embedded in the flat panel display, the touch sensing apparatus comprising:
a period signal generation unit configured to generate a period signal;
a flat panel display configured to comprise the capacitive type touch sensor panel for recognizing a touch operation;
a first reception unit configured to operate in response to an output signal of the touch sensor panel;
a second reception unit configured to receive an output signal of the first reception unit and the output of the period signal generation unit and generate a final output signal;
a feedback signal generation unit configured to operate in response to the output signal of the first reception unit; and
a driving signal generation unit coupled to the output signal of the period signal generation unit and an output signal of the feedback signal generation unit and configured to generate a touch sensor panel driving signal and input the touch sensor panel driving signal to an input terminal of the touch sensor panel.

31. The sensing apparatus of claim 30, wherein the feedback signal generation unit receives the output signals of the first reception unit, outputs a feedback signal proportional to a mean value of the output signals of the first reception unit, and applies the feedback signal to the driving signal generation unit.

32. The sensing apparatus of claim 30, wherein:
the first reception unit comprises a charge amplifier, and
the charge amplifier comprises an operational amplifier.

33. The sensing apparatus of claim 30, wherein:
the second reception unit comprises a multiplication circuit for multiplying some of or all the output signals of the first reception unit and the output signal of the period signal generation unit together and an integration filter for receiving an output signal of the multiplication through an input terminal,
the multiplication circuit comprises any one of a multiplier and a chopper circuit, and
the integration filter comprises any one of an integrator and a low-pass filter.

34. The sensing apparatus of claim 22 wherein a transfer function of the charge amplifier, comprising mutual capacitance between an electrode of the touch sensor panel in a first direction and an electrode of the touch sensor panel in a second direction and self-capacitance between the electrode in the second direction and an common electrode VCOM of the flat panel display, has a frequency characteristic of a band-pass characteristic.

35. The sensing apparatus of claim 5, wherein a frequency characteristic of a transfer function of the charge amplifier has a band-pass characteristic in order to prevent a phenomenon in which voltage at an output terminal of the operational amplifier included in the charge amplifier is saturated.

36. The sensing apparatus of claim 5, wherein the charge amplifier prevents a phenomenon in which voltage at an output terminal of the operational amplifier is saturated using a self-high frequency characteristic of the operational amplifier.

37. The sensing apparatus of claim 5, wherein a frequency of the output signal of the period signal generation unit is within a range of a pass band of a transfer function of the charge amplifier.

38. The sensing apparatus of claim 5, wherein a resonant frequency of the resonator is within a range of a pass band of a transfer function of the charge amplifier.

39. The sensing apparatus of claim 22, wherein frequency components having a range of 90% to 110% of a resonant frequency of the resonator, of frequency components for common electrode (VCOM) noise of the flat panel display, are attenuated by a negative feedback operation, and attenuated frequency components appear in the final output signal.

40. The sensing apparatus of claim 32, wherein a transfer function of the charge amplifier, comprising mutual capacitance between an electrode of the touch sensor panel in a first direction and an electrode of the touch sensor panel in a second direction and self-capacitance between the electrode in the second direction and an common electrode VCOM of the flat panel display, has a frequency characteristic of a band-pass characteristic.

41. The sensing apparatus of claim 22, wherein a frequency characteristic of a transfer function of the charge amplifier has a band-pass characteristic in order to prevent a phenomenon in which voltage at an output terminal of the operational amplifier included in the charge amplifier is saturated.

42. The sensing apparatus of claim 32, wherein a frequency characteristic of a transfer function of the charge amplifier has a band-pass characteristic in order to prevent a phenomenon in which voltage at an output terminal of the operational amplifier included in the charge amplifier is saturated.

43. The sensing apparatus of claim 22, wherein the charge amplifier prevents a phenomenon in which voltage at an output terminal of the operational amplifier is saturated using a self-high frequency characteristic of the operational amplifier.

44. The sensing apparatus of claim 32, wherein the charge amplifier prevents a phenomenon in which voltage at an output terminal of the operational amplifier is saturated using a self-high frequency characteristic of the operational amplifier.

45. The sensing apparatus of claim 22, wherein a frequency of the output signal of the period signal generation unit is within a range of a pass band of a transfer function of the charge amplifier.

46. The sensing apparatus of claim 32, wherein a frequency of the output signal of the period signal generation unit is within a range of a pass band of a transfer function of the charge amplifier.

47. The sensing apparatus of claim 22, wherein a resonant frequency of the resonator is within a range of a pass band of a transfer function of the charge amplifier.

48. The sensing apparatus of claim 32, wherein a resonant frequency of the resonator is within a range of a pass band of a transfer function of the charge amplifier.

49. The sensing apparatus of claim 32, wherein frequency components having a range of 90% to 110% of a resonant frequency of the resonator, of frequency components for common electrode (VCOM) noise of the flat panel display, are attenuated by a negative feedback operation, and attenuated frequency components appear in the final output signal.
